(19) United States
(12) Patent Application Publication
(10) Pub. No.: US 2024/0301532 A1
(43) Pub. Date: Sep. 12, 2024

(54) SELECTIVE METAL RECOVERY

(71) Applicant: Khalifa University of Science and Technology, Abu Dhabi (AE)

(72) Inventors: Giovanni PALMISANO, Abu Dhabi (AE); Marica MUSCETTA, Napoli (IT); Roberto ANDREOZZI, Napoli (IT); Raffaele MAROTTA, Napoli (IT); Laura CLARIZIA, Napoli (IT); Ilaria DI SOMMA, Napoli (IT); Marco RACE, Cassino (IT)

(21) Appl. No.: 18/597,012

(22) Filed: Mar. 6, 2024

Related U.S. Application Data
(60) Provisional application No. 63/450,358, filed on Mar. 6, 2023.

(51) Int. Cl. C22B 11/00; C22B 3/16; C22B 7/00; C22B 15/00

(52) U.S. Cl. CPC C22B 11/042; C22B 3/165; C22B 7/007; C22B 15/0069

(57) ABSTRACT

A method of recovering gold from a metal combination includes contacting the metal combination with a first leaching liquid sufficient to oxidize one or more additional metals of the metal combination to produce an oxidized product liquid and a recovered gold product, wherein the first leaching liquid includes chloride ions.

### CROSS-REFERENCE TO RELATED APPLICATION

This application claims benefit of U.S. Provisional Application No. 63/450,358, filed on Mar. 6, 2023. U.S. Provisional Application No. 63/450,358 is incorporated herein by reference. A claim of priority is made.

### BACKGROUND

The growth in produced and utilized electronic devices has led to an increased amount of electronic waste materials. These electronic waste materials and other metal scraps such as electrodes, batteries, and exhausted catalysts include valuable metals that can be recycled and reused for other applications and processes. Currently, one method for recovering metals from scraps includes using many working units, strong acidic conditions, and high temperatures. Not only are these conditions unfavorable due to the harsh acidic conditions, but the process is very energy intensive. An alternative method for recovering metals from scraps includes separation methods such as membrane separation. These methods also require many operating units and have low metal selectivity. Further, these current processes are not able to efficiently and selectively recover specific metals from metal combinations. Embodiments of the present disclosure provide novel systems and methods for selectively recovering metals, such as gold, from metal combinations. Further, these systems and methods of the present disclosure are capable of operating at mild pH values and are highly selective.

### SUMMARY

According to one embodiment, a method of recovering gold from a metal combination includes contacting the metal combination with a first leaching liquid sufficient to oxidize one or more additional metals of the metal combination to produce an oxidized product liquid and a recovered gold product, wherein the first leaching liquid includes chloride ions.

According to another embodiment, a method of recovering gold from a metal combination includes (1) contacting the metal combination with a first leaching liquid sufficient to oxidize one or more additional metals of the metal combination to produce an oxidized product liquid and a recovered gold product, wherein the first leaching liquid includes chloride ions; (2) contacting the recovered gold product with a second leaching liquid include at least one of glycine and hydrogen peroxide to produce a gold solution; (3) photocatalytically depositing gold in the gold solution on zinc oxide; and (4) dissolution of zinc oxide at a pH value below 6.3.

According to another embodiment, a system for recovering gold from a metal combination includes (1) a first reactor including a first reservoir and a first leaching liquid capable of oxidizing one or more metals in the metal combination to produce an oxidized product liquid and a recovered gold product, wherein the first leaching liquid includes chloride ions, and wherein the metal combination includes gold and one or more of silver, copper, nickel, and palladium; and (2) a second reactor including a second reservoir and a second leaching liquid for converting the recovered gold product to gold ions, wherein the second leaching liquid includes one or more of glycine and hydrogen peroxide, and wherein the pH value of the second leaching liquid is greater than the pH value of the first leaching liquid.

According to another embodiment, a method of selectively separating metals from a metal combination includes contacting the metal combination with a leaching liquid to oxidize one or more metals of the metal combination, wherein the metal combination includes two or more of silver, gold, copper, nickel, and palladium; and treating the one or more oxidized metals and the leaching liquid by increasing the pH value of the leaching liquid, sufficient to precipitate at least one of the one or more oxidized metals and to form a pH adjusted liquid.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 illustrates method 100 for recovering gold from a metal combination, according to some embodiments.

FIG. 2 illustrates method 200 for recovering gold from a metal combination, according to some embodiments.

FIG. 3 illustrates system 300 for recovering gold from a metal combination, according to some embodiments.

FIG. 4 illustrates method 400 for selectively separating metals from a metal combination, according to some embodiments.

FIG. 5 illustrates system 500 for selectively separating metals from a metal combination, according to some embodiments.

FIG. 6 illustrates a method for recovering gold from a metal combination, according to some embodiments.

FIG. 7 illustrates a method for selectively separating metals from a metal combination, according to some embodiments.

FIG. 8A illustrates the metal dissolution efficiency for silver, according to some embodiments.

FIG. 8B illustrates the metal dissolution efficiency for nickel, according to some embodiments.

FIG. 8C illustrates the metal dissolution efficiency for palladium, according to some embodiments.

FIG. 9 illustrates the gold dissolution efficiency in the presence of glycine, according to some embodiments.

FIG. 10 illustrates evolution of the gold photodeposition on zinc oxide, according to some embodiments.

FIG. 11 illustrates metal recovery efficiency under mild acidic conditions, according to some embodiments.

FIG. 12 illustrates gold dissolution efficiency, evolution of hydrogen peroxide, and evolution of glycine, according to some embodiments.

FIG. 13 illustrates evolution of gold photodeposition on zinc oxide, according to some embodiments.

FIG. 14 illustrates the metal dissolved fraction before and after pH adjustment, according to some embodiments.

FIG. 15 illustrates evolution of nickel and copper photodeposition on titanium dioxide, according to some embodiments.

FIG. 16A illustrates selective palladium deposition, according to some embodiments.

FIG. 16B illustrates selective silver deposition, according to some embodiments.

FIG. 17 illustrates pre-processing of electronic wastes and recovering metals, according to some embodiments.

FIG. 18 illustrates scanning electron microscope (SEM) images of pulverized Ni-based multilayer ceramic capacitors (MLCC), according to some embodiments.

FIG. 19 illustrates particle size distribution of spent Ni-MLCC, according to some embodiments.

FIG. 20A illustrates optical microscope images of solid particles at a particle dimension (μm) less than 70, according to some embodiments.

FIG. 20B illustrates optical microscope images of solid particles at a particle dimension (μm) between 70 and 125, according to some embodiments.

FIG. 20C illustrates optical microscope images of solid particles at a particle dimension (μm) between 125 and 180, according to some embodiments.

FIG. 20D illustrates optical microscope images of solid particles at a particle dimension (μm) between 180 and 212, according to some embodiments.

FIG. 20E illustrates optical microscope images of solid particles at a particle dimension (μm) between 212 and 300, according to some embodiments.

FIG. 20F illustrates optical microscope images of solid particles at a particle dimension (μm) greater than 300, according to some embodiments.

FIG. 21A illustrates dissolved nickel fraction against time from pure Ni powders and pulverized MLCCs, according to some embodiments.

FIG. 21B illustrates dissolved nickel fraction after 120 minutes from different MLCC granulometric fractions, according to some embodiments.

FIG. 22A illustrates an image of a spent Au/TiO₂ catalyst, according to some embodiments.

FIG. 22B illustrates a transmission electron microscope (TEM) of Au/TiO₂ catalyst, according to some embodiments.

FIG. 22C illustrates UV-Vis diffuse reflectance absorbance spectra of TiO₂ and Au/TiO₂ catalysts, according to some embodiments.

FIG. 23A illustrates gold dissolution efficiency during a leaching experiment at varying hydrogen peroxide initial concentrations, according to some embodiments.

FIG. 23B illustrates evolution of hydrogen peroxide during a leaching experiment at varying hydrogen peroxide initial concentrations, according to some embodiments.

FIG. 23C illustrates evolution of glycine during a leaching experiment at varying hydrogen peroxide initial concentrations, according to some embodiments.

FIG. 24 illustrates gold dissolution efficiency during a leaching experiment with varying glycine initial concentrations, according to some embodiments.

FIG. 25 illustrates evolution of gold photodeposition on ZnO under UV-A radiation, according to some embodiments.

FIG. 26 illustrates an X-ray powder diffraction (XRD) pattern of gold deposited on ZnO, according to some embodiments.

FIG. 27A illustrates a catalytic converter, according to some embodiments.

FIG. 27B illustrates a catalytic converter after preprocessing, according to some embodiments.

FIG. 28 illustrates a method of recovering silver from spent electrodes, according to some embodiments.

FIG. 29 illustrates gel removal from an electrode, according to some embodiments.

FIG. 30A illustrates the silver recovery efficiency based on chloride concentration, according to some embodiments.

FIG. 30B illustrates the silver recovery efficiency based on copper concentration, according to some embodiments.

FIG. 30C illustrates the silver recovery efficiency based on pH value, according to some embodiments.

FIG. 30D illustrates the silver recovery efficiency based on temperature, according to some embodiments.

FIG. 31 illustrates leaching recovery efficiency for electrodes, according to some embodiments.

FIG. 32 illustrates an XRD pattern of silver and silver deposited on ZnO, according to some embodiments.

### DETAILED DESCRIPTION

Metal combinations such as electronic waste, spent catalysts, electrodes, and batteries include valuable metals that can be recovered and reused. Examples of metals in these metal combinations include silver, gold, copper, nickel, titanium, and palladium. Embodiments of the present disclosure describe a novel approach to selectively recover metals from electronic waste, scrap metals, and other metal combinations. Compared to current metal recovery processes that require harsh acidic conditions, high temperatures, and/or many unit operations (e.g., magnetic separation, cementation, electrowinning, activated carbon adsorption, ion exchange), systems and methods of the present disclosure are capable of selectively recovering and separating metals from metal combinations at mild conditions (such as mild pH conditions) with high selectivity values.

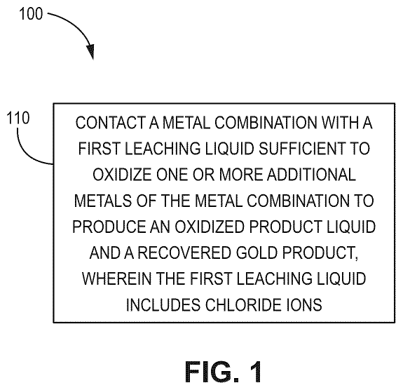

FIG. 1 illustrates method 100 for recovering gold from a metal combination, according to some embodiments. Method 100 includes the following step:

At Step 110, a metal combination is contacted with a first leaching liquid sufficient to oxidize one or more additional metals of the metal combination to produce an oxidized product liquid and a recovered gold product, wherein the first leaching liquid includes chloride ions. Contacting the metal combination with the first leaching liquid may include physical contact, stirring, submerging, and/or reacting. Method 100 may further include dismantling and/or pulverization of the metal combination prior to Step 110. Step 110 may further include filtering a formed suspension to separate the oxidized product liquid from the recovered gold product.

The metal combination may include metals from electronic waste, electrodes, catalysts, and/or batteries. In one example, the metal combination includes one or more of gold, silver, copper, nickel, titanium, and palladium. In another example, the metal combination includes two or more of gold, silver, copper, nickel, titanium, and palladium. In yet another example, the metal combination includes gold and one or more additional metals. The additional metals may include at least one of silver, copper, nickel, and palladium. One non-limiting example of electronic waste is random-access memory (RAM). RAM may include 95-98 wt. % copper, 1-4 wt. % nickel, 0.1-0.5 wt. % silver, 0.04-0.13 wt. % gold, and 0.004-0.008 wt. % palladium. In one non-limiting example, method 100 may be used for recovering gold from a catalyst including titanium and gold.

The first leaching liquid may be a water solution. In one example, the first leaching liquid includes chloride ions. In another example, the first leaching liquid includes chloride ions and copper. In another example, the first leaching liquid includes at least one of sodium chloride, copper chloride, copper sulfate, and an iodide-containing compound. In yet another example, the first leaching liquid includes sodium chloride (such as 4-6 M) and copper chloride (such as 1-12 mM). Chloride ions can form complexes in redox reactions, and the chlorides can modify the reduction potential to improve oxidation. Accordingly, these chloride ions can improve reactivity under mild acidic conditions by altering the electrochemical potential.

The pH value of the first leaching liquid may be greater than about 4 pH or greater than about 5 pH. The pH value of the first leaching liquid may range from about 4 pH to about 6 pH. For example, the pH value of the first leaching liquid may range from about 4 pH to about 5 pH. Importantly, compared to methods that recover metals using strong acids (such as sulfuric acid) at pH values below about 3 pH, the instant method is capable of separating metals at milder acidic conditions. The metal combination may be contacted and mixed with the first leaching liquid at a temperature ranging from about 30° C. to about 80° C. In one example, the metal combination is contacted and mixed with the first leaching liquid at a temperature ranging from about 50° C. to about 70° C. In another example, the metal combination is contacted and mixed with the first leaching liquid at a temperature below 80° C. The stirring rate of the first leaching liquid may be set at about 200 rpm to about 700 rpm. In one example, the stirring rate of the first leaching liquid is set at about 500 rpm.

Additionally, air flow may be introduced to improve oxidation of metal(s). In one example, about 0.2 L/min to about 1 L/min of air is introduced to improve oxidation of metal(s). In another example, about 0.2 L/min to about 0.5 L/min of air is introduced to improve oxidation of metal(s). The reaction may be carried out for 10 or more minutes. In one example, the reaction is carried out for 60 or more minutes. In another example, the reaction is carried out for about 120 minutes. This reaction may be performed in an annular glass batch reactor equipped with a stirring system.

Step 110 may be sufficient for a total, or substantial, dissolution of one or more metals of the metal combination. The oxidized product liquid may include the first leaching liquid and one or more oxidized metals. This oxidized product liquid may be in the form of a solution and may be substantially or completely free of gold since gold does not dissolve in the solution. In one example, the oxidized product liquid includes one or more of Ag¹⁺, Pd²⁺, Ni²⁺, and Cu²⁺. In another example, the oxidized product liquid includes two or more of Ag¹⁺, Pd²⁺, Ni²⁺, Cu²⁺, and NaCl. These oxidized metals may be transferred to a downstream processing unit for further recovery. For example, the pH value of the oxidized product liquid may be increased in a downstream process to further recover metal(s).

The recovered gold product may include a solid-phase, non-oxidized gold product. The majority of the solid-phase product may be gold. This recovered gold product may be transferred to a downstream processing unit for further recovery. The recovered gold product may be contacted with a second leaching liquid, wherein the pH value of the second leaching liquid is greater than the pH value of the first leaching liquid (as further described herein). For example, the second leaching liquid may include one or more of hydrogen peroxide and glycine.

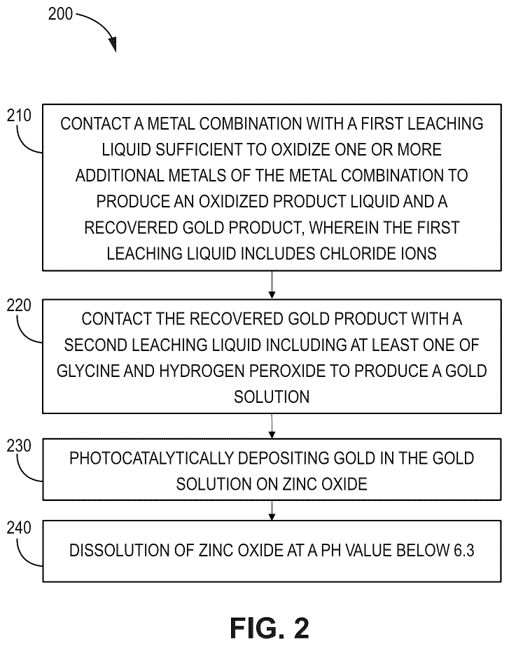

FIG. 2 illustrates method 200 for recovering gold from a metal combination, according to some embodiments. Method 200 includes the following steps:

At Step 210, a metal combination is contacted with a first leaching liquid sufficient to oxidize one or more additional metals of the metal combination to produce an oxidized product liquid and a recovered gold product, wherein the first leaching liquid includes chloride ions. Step 210 includes any embodiments of step 110. Method 200 may further include dismantling and/or pulverization of the metal combination prior to Step 210. Step 210 may further include filtering a formed suspension to separate the oxidized product liquid from the recovered gold product.

At Step 220, the recovered gold product is contacted with a second leaching liquid including at least one of glycine and hydrogen peroxide to produce a gold solution (and/or gold suspension). Contacting the recovered gold product with the second leaching liquid may include physical contact, stirring, submerging, and/or reacting. The second leaching liquid may include a water solution. In one example, the second leaching liquid includes glycine (such as 0.1-1 M) and hydrogen peroxide (such as 0.4-0.8 M). The pH value of the second leaching liquid is generally greater than the pH value of the first leaching liquid. In one example, the pH value of the second leaching liquid is greater than about 6 pH. In another example, the pH value of the second leaching liquid is greater than about 10 pH. In yet another example, the pH value of the second leaching liquid ranges from about 11 pH to about 13.5 pH.

The recovered gold may be contacted and mixed with the second leaching liquid at a temperature ranging from about 30° C. to about 80° C. In one example, recovered gold may be contacted and mixed with the second leaching liquid at a temperature ranging from about 50° C. to about 70° C. In another example, recovered gold may be contacted and mixed with the second leaching liquid at a temperature below 80° C. Compared to systems that utilize high temperatures (such as temperatures ranging from 95° C. to 800° C.), the instant method is capable of efficiently recovering gold at much milder temperatures.

The stirring rate of the second leaching liquid may be set at about 200 rpm to about 700 rpm. In one example, the stirring rate of the second leaching liquid is set at about 500 rpm. The reaction may be carried out for 10 or more minutes. In one example, the reaction is carried out for 100 or more minutes. In another example, the reaction is carried out for about 180 minutes. This reaction may be performed in an annular glass batch reactor equipped with a stirring system. The produced gold solution in Step 220 may include Au¹⁺ ions and glycine.

At Step 230, gold in the gold solution is photocatalytically deposited on zinc oxide. At Step 230, a catalyst may be contacted with the gold solution. In one example, the catalyst is a photocatalyst. The photocatalyst may be a metal oxide photocatalyst. For example, the photocatalyst may include zinc oxide (ZnO), iron oxide (Fe₂O₃), copper oxide (CuO), and/or cuprous oxide (Cu₂O). Other examples include zinc sulfide (ZnS) and cadmium sulfide (CdS). At Step 230, the pH value of the gold solution may be less than the second leaching liquid. For example, the pH value of the gold solution may range from about 7 pH to about 9 pH. In one example, the pH value of the gold solution is about 8 pH.

The gold solution may be contacted with the catalyst at a temperature below 50° C. In one example, the gold solution is contacted with the catalyst at a temperature ranging from about 20° C. to about 35° C. In another example, the gold solution is contacted with the catalyst at a temperature of about 25° C. The reaction may be carried out for 30 or more minutes. In one example, the reaction is carried out for 60 or more minutes. In another example, the reaction is carried out for about 120 minutes. This reaction may be performed in an annular glass batch reactor equipped with a stirring system. Water or other liquids may be utilized in a sleeve to maintain a constant temperature.

Step 230 may further include applying radiation to one or more of the gold solution and the catalyst. Applying radiation may activate and/or speed up the deposition process. In one example, applying radiation reduces one or more metals. In another example, applying radiation includes applying UV-A radiation. UV-A radiation may be applied using a high pressure mercury lamp. For example, visible UV-A radiation may be applied with a 100 W to 150 W high pressure mercury lamp. In addition, or alternatively, the process can be carried out under solar radiation, by using the UV component of the solar spectrum.

Step 230 may further include contacting the gold solution with a gas. In one example, the gas includes one or more of nitrogen gas, argon gas, and carbon dioxide gas. In one example, the flow rate of gas ranges from about 0.1 L/min to about 1 L/min. In another example, the flow rate of gas ranges from about 0.2 L/min to about 0.5 L/min. Importantly, this gas flow can prevent and/or reduce reactions between dissolved oxygen and photogenerated electrons. Step 230 generally forms two phases: (1) a liquid phase including unreacted glycine (such as a glycine-peroxide solution); and (2) a solid phase including metallic gold deposited on the catalyst. For example, metallic gold may be deposited on zinc oxide.

At step 240, dissolution of zinc oxide is performed at a pH value below 6.3. The solid phase from Step 230 may be contacted with water. The pH value of the water is generally below 6.3 pH. In one example, the pH value of the water is lower than 6.0 pH. In another example, the pH value of the water is about 5.0 pH. At Step 240, the zinc oxide (such as zinc oxide nanoparticles) dissolve in the water, allowing the effective recovery of metallic gold. Zinc nitrate solution recycling may be performed to prepare additional photocatalytic materials.

The reactor used may be an annular glass batch reactor equipped with a stirring system and a cooling jacket. The metallic gold deposited on zinc oxide may be contacted with water at a temperature ranging from about 15° C. to about 30° C. In one example, the metallic gold deposited on zinc oxide may be contacted with water at a temperature ranging from about 18° C. to about 25° C. The stirring rate may range from about 200 rpm to about 800 rpm. For example, the stirring rate may be set at about 500 rpm. Additionally, an air flux may be flowed to carry out oxidation of copper eventually deposited on the zinc oxide. For example, an air flow rate ranging from about 0.1 L/min to about 1 L/min may be utilized. Step 240 may form two distinct products: (1) metallic gold; and (2) Zn²⁺, NO₃⁻, and/or Cu(II) impurities.

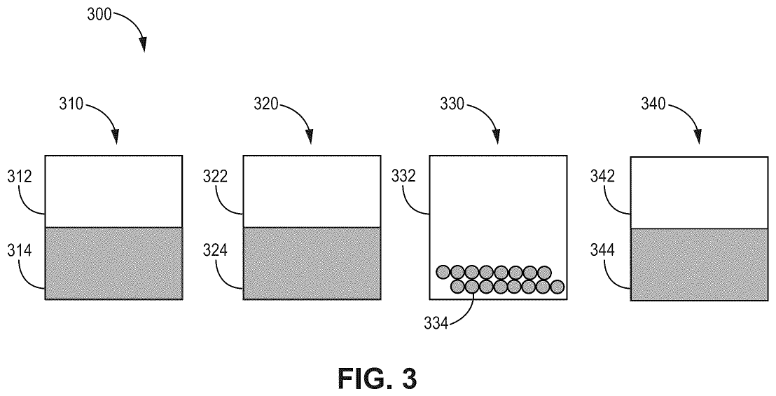

FIG. 3 illustrates system 300 for recovering gold from a metal combination, according to some embodiments. System 300 includes first reactor 310, second reactor 320, third reactor 330, and/or fourth reactor 340.

First reactor 310 includes first reservoir 312 and first leaching liquid 314. First reactor 310 may be an annular glass batch reactor with a stirring system. First reservoir 312 may be a vessel for holding or partially containing one or more fluids. A metal combination may be added to the first reactor 310. First reactor 310 and first leaching liquid 314 are capable of oxidizing one or more metals in the metal combination to produce an oxidized product liquid and a recovered gold product.

The metal combination may include metals from electronic waste, electrodes, catalysts, and/or batteries. In one example, the metal combination includes one or more of gold, silver, copper, nickel, titanium, and palladium. In another example, the metal combination includes two or more of gold, silver, copper, nickel, titanium, and palladium. In yet another example, the metal combination includes gold and one or more additional metals. The additional metals may include at least one of silver, copper, nickel, and palladium.

The first leaching liquid 314 may be a water solution. In one example, the first leaching liquid 314 includes chloride ions. In another example, the first leaching liquid 314 includes chloride ions and copper. In another example, the first leaching liquid 314 includes at least one of sodium chloride, copper chloride, copper sulfate, and an iodide-containing compound. In yet another example, the first leaching liquid 314 includes sodium chloride (such as 4-6 M) and copper chloride (such as 1-10 mM). The pH value of the first leaching liquid 314 may be greater than about 4 pH or greater than about 5 pH. The pH value of the first leaching liquid 314 may range from about 4 pH to about 6 pH. For example, the pH value of the first leaching liquid 314 may range from about 4 pH to about 5 pH.

The oxidized product liquid may include the first leaching liquid 314 and one or more oxidized metals. This oxidized product liquid may be in the form of a solution. In one example, the oxidized product liquid includes one or more of Ag¹⁺, Pd²⁺, Ni²⁺, and Cu²⁺. In another example, the oxidized product liquid includes two or more of Ag¹⁺, Pd²⁺, Ni²⁺, Cu²⁺, and NaCl. These oxidized metals may be transferred to a downstream processing unit for further recovery. For example, the pH value of the oxidized product liquid may be increased in a downstream process to further recover metal(s). Additionally, air flow may be introduced to improve oxidation of metal(s). In one example, about 0.2 L/min to about 1 L/min of air is introduced to improve oxidation of metal(s). In another example, about 0.2 L/min to about 0.5 L/min of air is introduced to improve oxidation of metal(s).

Second reactor 320 includes second reservoir 322 and second leaching liquid 324. Second reactor 320 may be an annular glass batch reactor with a stirring system. Second reservoir 322 may be a vessel for holding or partially containing one or more fluids. A solid-phase (including gold) from first reactor 310 may be transferred to second reactor 320. Second reactor 320 and second leaching liquid 324 are capable of converting the recovered gold product (from first reactor 310) to gold ions. Accordingly, second reactor 320 may form an Au¹⁺ and glycine-peroxide solution. This Au¹⁺ and glycine-peroxide solution can be transferred to a downstream process for further gold recovery.

The second leaching liquid 324 may be a water solution. In one example, the second leaching liquid 324 includes glycine (such as 0.1-1 M) and hydrogen peroxide (such as 0.4-0.8 M). The pH value of the second leaching liquid 324 is generally greater than the pH value of the first leaching liquid 314. In one example, the pH value of the second leaching liquid 324 is greater than about 6 pH. In another example, the pH value of the second leaching liquid 324 is greater than about 10 pH. In yet another example, the pH value of the second leaching liquid 324 ranges from about 11 pH to about 13.5 pH.

Third reactor 330 includes third reservoir 332 and photocatalyst 334. Third reservoir 332 may be a vessel for holding or partially containing one or more fluids and/or photocatalyst 334. In one example, third reactor 330 is an annular glass batch reactor equipped with a magnetic stirrer. In another example, third reactor 330 is an annular glass batch reactor equipped with a stirring system and a radiation lamp in a quartz sleeve. The Au¹⁺ solution from second reactor 320 may be transferred to third reactor 330, where third reactor 330 is used for photodeposition of the gold on photocatalyst 334. The photocatalyst 334 may include a zinc oxide photocatalyst for producing a photocatalytic product. Photocatalysts of Step 230 above may be utilized. Accordingly, the photocatalytic product may include metallic gold and zinc oxide.

The third reactor 330 may utilize an inlet gas. In one example, the gas includes one or more of nitrogen gas, argon gas, and carbon dioxide gas. In another example, the flow rate of gas ranges from about 0.1 L/min to about 1 L/min. In another example, the flow rate of gas ranges from about 0.2 L/min to about 0.5 L/min. Importantly, this gas flow can prevent and/or reduce reactions between dissolved oxygen and photogenerated electrons. The pH value of liquid(s) in the third reactor may be maintained between about 7 pH and about 10 pH. In one example, the pH value of liquid(s) in the third reactor is maintained between about 7 pH and about 9 pH. In another example, the pH value of liquid(s) in the third reactor is maintained at about 8 pH.

Third reactor 330 may further include a radiation lamp. In one example, third reactor 330 includes a UV-A radiation lamp. Visible UV-A radiation may be applied with a 100 W to 150 W high pressure mercury lamp. By using UV-A radiation, gold can be completely, or substantially, deposited on the photocatalyst. This UV-A light source can easily reduce metals on the photocatalyst. In addition, or alternatively, the process can be carried out under solar radiation, by using the UV component of the solar spectrum. Third reactor 330 is capable of producing two products: (1) a liquid phase including non-reacted components of second leaching liquid 324; and (2) a solid phase including metallic gold and the photocatalyst 334.

Fourth reactor 340 includes fourth reservoir 342 and solvent 344. Fourth reservoir 342 may be a vessel for holding or partially containing one or more fluids. In one example, fourth reactor 340 is an annular glass batch reactor equipped with a stirring system. In another example, fourth reactor 340 is an annular glass batch reactor equipped with a magnetic stirrer and a cooling jacket. Fourth reactor 340 is capable of effectively recovering gold from the solid phase product of third reactor 330. Accordingly, fourth reactor 340 is capable of separating metallic gold from photocatalyst 334 when the solid phase product of third reactor 330 is contacted with solvent 344.

Solvent 344 may include a water solution capable of dissolving photocatalyst 334. In one example, the pH value of solvent 344 is less than 6.3 pH. In another example, the pH value of solvent 344 is less than about 6.0 pH. The metallic gold deposited on photocatalyst 334 may be contacted with water at a temperature ranging from about 15° C. to about 30° C. In one example, the metallic gold deposited on photocatalyst 334 may be contacted with water at a temperature ranging from about 18° C. to about 25° C. The stirring rate may range from about 200 rpm to about 800 rpm. For example, the stirring rate may be set at about 500 rpm. Additionally, an air flux may be flowed to carry out oxidation of copper eventually deposited on the zinc oxide. For example, an air flow rate ranging from about 0.1 L/min to about 1 L/min may be utilized. Fourth reactor 340 may form two distinct products: (1) metallic gold; and (2) Zn²⁺, NO₃⁻, and/or Cu(II) impurities.

Surprisingly, it was found that method 100, method 200, and system 300 can be utilized to effectively recover gold from a metal combination. For example, a leaching liquid including one or more of chloride ions and copper may be utilized to effectively separate gold from other metals. These systems and methods are capable of recovering gold at mild temperatures and pH values (such as greater than about 3 pH). For example, by oxidizing metals in a metal combination, gold can be efficiently recovered from other species in the metal combination. Importantly, gold can be separated from other metals such as nickel, copper, silver, and palladium in a single step or unit operation. Further, these systems and methods do not require membranes, which are typically expensive and provide lower selectivity values.

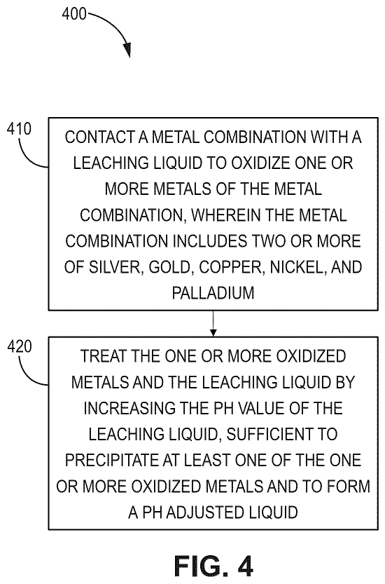

FIG. 4 illustrates method 400 for selectively separating metals from a metal combination, according to some embodiments. Method 400 includes methods of separating metals in electronic waste. Method 400 includes the following steps:

At step 410, a metal combination is contacted with a leaching liquid to oxidize one or more metals of the metal combination, wherein the metal combination includes two or more of silver, gold, copper, nickel, titanium, and palladium. The metal combination may include metals from electronic waste, electrodes, catalysts, and/or batteries. In yet another example, the metal combination includes gold and one or more additional metals. The additional metals may include at least one of silver, copper, nickel, and palladium. One non-limiting example of electronic waste is random-access memory (RAM). Method 400 may further include dismantling and/or pulverization of the metal combination prior to Step 410. Step 410 may further include filtering one or more non-oxidized metals.

The leaching liquid may be a water solution. In one example, the leaching liquid includes chloride ions. In another example, the leaching liquid includes chloride ions and copper. In another example, the leaching liquid includes at least one of sodium chloride, copper chloride, copper sulfate, and an iodide-containing compound. In yet another example, the leaching liquid includes sodium chloride (such as 4-6 M) and copper chloride (such as 1-12 mM). The pH value of the leaching liquid may be greater than about 4 pH or greater than about 5 pH. The pH value of the leaching liquid may range from about 4 pH to about 6 pH. For example, the pH value of the leaching liquid may range from about 4 pH to about 5 pH. Importantly, compared to methods that recover strong acids (such as sulfuric acid) at pH values below about 3-4 pH, the instant method is capable of separating metals at milder acidic conditions.

The composition and concentration of the leaching liquid may be tuned for specific metal combinations. For example, the chlorides may be increased to near the saturation of the solution to increase efficiency, and copper may be utilized in the leaching liquid as an oxidizing agent. The amount of copper in the leaching liquid may be tuned according to the redox potential. If the metal combination includes palladium, a ratio of copper to palladium of at least about 2 may be used, which is greater than the stoichiometric value. If the metal combination includes nickel, a ratio of copper to nickel of at least about 2 may be used, which is greater than the stoichiometric value.

The metal combination may be contacted and mixed with the leaching liquid at a temperature ranging from about 30° C. to about 80° C. In one example, the metal combination is contacted and mixed with the leaching liquid at a temperature ranging from about 50° C. to about 70° C. In another example, the metal combination is contacted and mixed with the leaching liquid at a temperature below 80° C. The stirring rate of the leaching liquid may be set at about 200 rpm to about 700 rpm. In one example, the stirring rate of the leaching liquid is set at about 500 rpm.

Additionally, air flow may be introduced to improve oxidation of metal(s). In one example, about 0.2 L/min to about 1 L/min of air is introduced to improve oxidation of metal(s). In another example, about 0.2 L/min to about 0.5 L/min of air is introduced to improve oxidation of metal(s). The reaction may be carried out for 10 or more minutes. In one example, the reaction is carried out for 60 or more minutes. In another example, the reaction is carried out for about 120 minutes. This reaction may be performed in an annular glass batch reactor equipped with a stirring system.

Step 410 may be sufficient for a total, or substantial, dissolution of one or more metals of the metal combination. The oxidized product liquid may include the leaching liquid and one or more oxidized metals. In one example, the oxidized product liquid includes one or more of Ag¹⁺, Pd²⁺, Ni²⁺, and Cu²⁺. In another example, the oxidized product liquid includes two or more of Ag¹⁺, Pd²⁺, Ni²⁺, Cu²⁺, and NaCl. If nickel and copper are not present in the metal combination, the oxidized product liquid of step 410 may be transferred directly to step 430. If gold is present in the metal combination, steps 220, 230, and 240 may also be performed to recover gold after step 410.

At step 420, the one or more oxidized metals and the leaching liquid are treated by increasing the pH value of the leaching liquid, sufficient to precipitate at least one of the one or more oxidized metals and to form a pH adjusted liquid. In one example, the pH value of the oxidized product liquid is increased to a pH value up to 8.0. In another example, the pH value of the oxidized product liquid is increased to a pH value between about 6 pH and about 8 pH. Step 420 may include contacting the oxidized product liquid from step 410 with a base to increase the pH value and achieve precipitation of metal(s). For example, the oxidized product liquid from step 410 may be contacted with a sodium hydroxide solution to achieve precipitation of metal(s). In one non-limiting example, step 420 precipitates copper and/or nickel in the form of hydroxides. The pH adjusted liquid may include one or more of Ag¹⁺, Pd²⁺, and NaCl.

If copper is precipitated in the form of a hydroxide (produced in step 420), method 400 may further include photocatalytic deposition of precipitated copper on a first catalyst. The first catalyst is generally a photocatalyst. In one example, the first catalyst includes titanium dioxide. Additionally, the precipitated metal(s) may be contacted with an organic liquid. Contacting may include physical contact, stirring, submerging, and/or reacting. In one example, the organic liquid includes one or more of formic acid, ethanol, and glycerol. The copper hydroxide precipitate may be photodeposited using an annular glass batch reactor equipped with a stirring system and a radiation source for applying radiation.

Photocatalytic deposition of precipitated copper may be performed at a temperature ranging from about 18° C. to about 35° C. For example, photocatalytic deposition of precipitated copper may be performed at a temperature ranging from about 23° C. to about 30° C. Photocatalytic deposition of precipitated copper may be performed at a pH value ranging from about 3.0 pH to about 6.0 pH. In one example, photocatalytic deposition of precipitated copper may be performed at a pH value of about 4 pH. Further, the organic liquid may be stirred at a rate ranging from 200 rpm to 1000 rpm. For example, the organic liquid may be stirred at a rate ranging from about 400 rpm to about 600 rpm.

The precipitated copper and/or the organic liquid may be contacted with a gas. In one example, the gas includes one or more of nitrogen gas, argon gas, and carbon dioxide gas. In another example, the flow rate of gas ranges from about 0.1 L/min to about 1 L/min. In another example, the flow rate of gas ranges from about 0.2 L/min to about 0.5 L/min. In one example, applying radiation includes applying UV-A radiation. UV-A radiation may be applied using a high pressure mercury lamp. For example, visible UV-A radiation may be applied with a 100 W to 150 W high pressure mercury lamp. The reaction may be carried out for at least 30 minutes, at least 45 minutes, or at least 60 minutes. The reaction is sufficient to deposit metallic copper on the first catalyst. If nickel hydroxide is present, a Ni²⁺ solution may be formed to effectively separate nickel.

After the photodeposition of copper on the first catalyst, the solid phase copper deposited on the first catalyst can be placed in a solution to oxidize and effectively recover copper. Air may be applied to the solution sufficient to oxidize zerovalent copper to copper (II), which can be separated from the first catalyst. In one example, the flow rate of air ranges from about 0.1 L/min to about 1 L/min. In another example, the flow rate of air ranges from about 0.2 L/min to about 0.5 L/min. Further, the solution may be stirred at a rate ranging from 200 rpm to 1000 rpm. For example, the solution may be stirred at a rate ranging from about 400 rpm to about 600 rpm. Oxidation of copper may be performed in an annular glass batch reactor equipped with a stirring system and cooling. This reaction may be carried out for about 30 minutes to about 150 minutes. In one example, this reaction is carried out for 60 minutes to 120 minutes. In one example, oxidizing the copper includes producing a Cu²⁺ product solution.

If palladium is present in the metal combination, method 400 may further include adsorption of palladium on a second catalyst. The pH adjusted liquid may include one or more of Ag¹⁺ and Pd²⁺. Accordingly, the pH adjusted liquid may be contacted with the second catalyst and a reducing agent. Contacting the pH adjusted liquid with the second catalyst and the reducing agent is sufficient for adsorption of Pd²⁺ on the second catalyst. In one example, the second catalyst includes zinc oxide. In another example, the reducing agent includes ethanol. The reducing agent assists in reducing the palladium.

Adsorption of palladium may be performed at a temperature ranging from about 18° C. to about 35° C. For example, adsorption of palladium may be performed at a temperature ranging from about 18° C. to about 25° C. The pH adjusted liquid may be stirred at a rate ranging from 200 rpm to 1000 rpm. For example, the pH adjusted liquid may be stirred at a rate ranging from about 400 rpm to about 600 rpm. The reaction may be performed using an annular glass batch reactor equipped with a stirring system and a cooling jacket. The adsorption may be performed under dark conditions, such as without the use of UV-A radiation. Importantly, if silver is present in the metal combination, the reactive adsorption of palladium can be performed under dark conditions (without the use of radiation) to prevent or reduce the simultaneous reduction of silver on the second catalyst.

After the adsorption of palladium on the photocatalyst, the solid phase palladium deposited on the second catalyst may be contacted with water, or other solvents, to dissolve the second catalyst and effectively recover palladium. In one example, water at a pH value lower than 6.3 pH is used to dissolve the second catalyst, such as zinc oxide. This pH adjustment may be completed using an acid, such as a nitric acid solution.

Dissolution of the second catalyst may be performed at a temperature ranging from about 18° C. to about 35° C. For example, dissolution of the second catalyst may be performed at a temperature ranging from about 18° C. to about 25° C. The reactants may be stirred at a rate ranging from 200 rpm to 1000 rpm. For example, the reactants may be stirred at a rate ranging from about 400 rpm to about 600 rpm. The reaction may be performed using an annular glass batch reactor equipped with a stirring system and a cooling jacket. In one example, based on the purity of spent zinc nitrate solution, the stream may be recycled to synthesize zinc oxide.

If silver is present in metal combination, method 400 may further include photocatalytic deposition of silver on a third catalyst (such as using a catalyst of the present disclosure). For example, a solution from the adsorption and reaction of Pd²⁺ may be transferred to effectively deposit silver. This solution may include one or more of Ag¹⁺, NaCl, and ethanol. The third catalyst is generally a photocatalyst. In one example, the third catalyst includes zinc oxide. Further, inlet gas may be used in this step. In one example, the gas includes one or more of nitrogen gas, argon gas, and carbon dioxide gas. In another example, the flow rate of gas ranges from about 0.1 L/min to about 1 L/min. In another example, the flow rate of gas ranges from about 0.2 L/min to about 0.5 L/min. Importantly, this gas flow can prevent and/or reduce reactions between dissolved oxygen and photogenerated electrons.

Photocatalytic deposition of silver on the third catalyst may be performed in an annular glass batch reactor equipped with a stirring system. UV-A radiation may be applied using a high-pressure mercury lamp. For example, visible UV-A radiation may be applied with a 100 W to 150 W high pressure mercury lamp. Further, a high-pressure mercury lamp located in a quartz sleeve may be used. Water may be used with the quartz sleeve to maintain a constant temperature.

Photocatalytic deposition of silver on the third catalyst may be performed at a temperature ranging from about 20° C. to about 40° C. In one example, photocatalytic deposition of silver on the third catalyst may be performed at a temperature ranging from about 22° C. to about 30° C. In another example, photocatalytic deposition of silver on the third catalyst may be performed at about 25° C. Photocatalytic deposition of silver on the third catalyst may be performed at a pH value above about 7 pH. In one example, photocatalytic deposition of silver on the third catalyst may be performed at a pH value ranging from about 7 pH to about 9 pH. In another example, photocatalytic deposition of silver on the third catalyst may be performed at a pH value of about 8 pH. The reaction may be performed for at least 60 minutes, at least 90 minutes, or at least 120 minutes. This reaction may form a liquid phase including sodium chloride and ethanol, and a solid phase including metallic silver deposited on the third catalyst.

After the photodeposition of silver on the third catalyst, the solid phase including metallic silver deposited on the third catalyst may be separated. The solid phase may be contacted with water, or other solvents, to dissolve the third catalyst and effectively recover silver. In one example, water at a pH value lower than 6.3 pH is used to dissolve the third catalyst, such as zinc oxide. This pH adjustment may be completed using an acid, such as a nitric acid solution.

Dissolution of the third catalyst may be performed at a temperature ranging from about 18° C. to about 35° C. For example, dissolution of the third catalyst may be performed at a temperature ranging from about 18° C. to about 25° C. The reactants may be stirred at a rate ranging from 200 rpm to 1000 rpm. For example, the reactants may be stirred at a rate ranging from about 400 rpm to about 600 rpm. The reaction may be performed using an annular glass batch reactor equipped with a stirring system and a cooling jacket. In one example, based on the purity of spent zinc nitrate solution, the stream may be recycled to synthesize zinc oxide. This step may form separated metallic silver and a Zn²⁺ product streams.

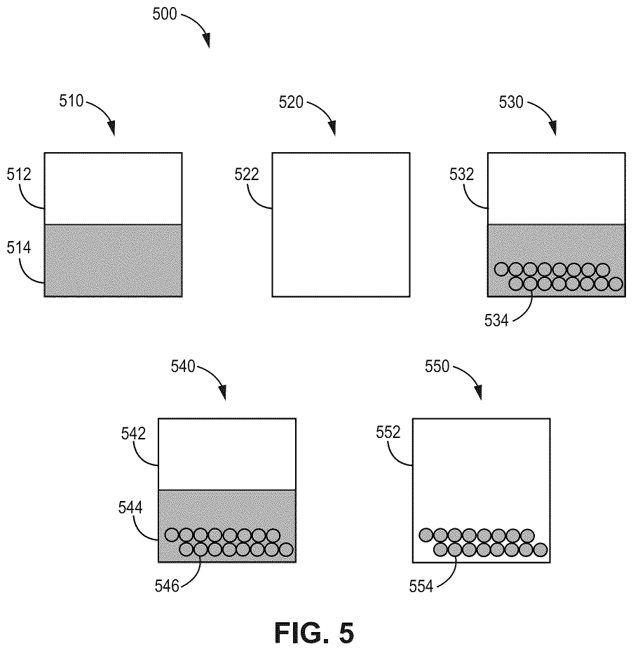

FIG. 5 illustrates system 500 for selectively separating metals from a metal combination, according to some embodiments. System 500 includes at least one of first reactor 510, second reactor 520, third reactor 530, fourth reactor 540, and fifth reactor 550. Importantly, system 500 can be tuned according to the starting composition of the metal combination. Further, system 500 may be used in conjunction with one or more components of system 300 to efficiently recover gold.

First reactor 510 includes first reservoir 512 and leaching liquid 514. First reactor 510 may be an annular glass batch reactor with a stirring system and/or heating or cooling jacket. First reservoir 512 may be a vessel for holding or partially containing one or more fluids. A metal combination may be added to the first reactor 510. First reactor 510 and leaching liquid 514 are capable of oxidizing one or more metals in the metal combination to produce an oxidized product liquid.

The metal combination may include metals from electronic waste, electrodes, catalysts, and/or batteries. In one example, the metal combination includes one or more of gold, silver, copper, nickel, titanium, and palladium. In another example, the metal combination includes two or more of gold, silver, copper, nickel, titanium, and palladium. In yet another example, the metal combination includes gold and one or more additional metals. The additional metals may include at least one of silver, copper, nickel, and palladium.

The leaching liquid 514 may be a water solution. In one example, leaching liquid 514 includes chloride ions. In another example, the leaching liquid 514 includes chloride ions and copper. In another example, the leaching liquid 514 includes at least one of sodium chloride, copper chloride, copper sulfate, and an iodide-containing compound. In yet another example, the leaching liquid 514 includes sodium chloride (such as 4-6 M) and copper chloride (such as 1-10 mM). The pH value of the leaching liquid 514 may be greater than about 4 pH or greater than about 5 pH. The pH value of the leaching liquid 514 may range from about 4 pH to about 6 pH. For example, the pH value of the leaching liquid 514 may range from about 4 pH to about 5 pH.

The oxidized product liquid may include the leaching liquid 514 and one or more oxidized metals. This oxidized product liquid may be in the form of a solution. In one example, the oxidized product liquid includes one or more of Ag¹⁺, Pd²⁺, Ni²⁺, and Cu²⁺. These oxidized metals may be transferred to a downstream processing unit for further recovery. For example, the pH value of the oxidized product liquid may be increased in a downstream process to further recover metal(s). In another example, the oxidized product liquid includes two or more of Ag¹⁺, Pd²⁺, Ni²⁺, Cu²⁺, and NaCl. Additionally, air flow may be introduced to improve oxidation of metal(s). In one example, about 0.2 L/min to about 1 L/min of air is introduced to improve oxidation of metal(s). In another example, about 0.2 L/min to about 0.5 L/min of air is introduced to improve oxidation of metal(s).

Second reactor 520 includes second reservoir 522. Second reactor 520 may include a base in second reservoir 522, or an inlet for a base, such as sodium hydroxide. Second reservoir 522 may be a vessel for holding or partially containing one or more fluids. Accordingly, second reactor 520 is capable of treating the one or more oxidized metals and the leaching liquid by increasing the pH value of the leaching liquid, sufficient to precipitate at least one of the one or more oxidized metals and to form a pH adjusted liquid.

In one example, the pH value of the leaching liquid is increased to a pH value up to 8.0. In another example, the pH value of the leaching liquid is increased to a pH value between about 6 pH and about 8 pH. In one non-limiting example, second reactor 520 precipitates copper and/or nickel in the form of hydroxides. The pH adjusted liquid may include one or more of Ag¹⁺, Pd²⁺, and NaCl.

Third reactor 530 includes third reservoir 532 and first catalyst 534. Third reactor 530 may be an annular glass batch reactor with a stirring system and radiation source. Third reservoir 532 may be a vessel for holding or partially containing one or more fluids. If the metal combination includes copper, the precipitated hydroxide(s) from second reactor 520 may be transferred to third reactor 530. Third reactor 530 is capable of photocatalytically depositing copper on first catalyst 534. If nickel and copper are present in the metal combination, third reactor 530 is capable of producing a liquid phase including nickel (Ni²⁺) and a solid phase including copper deposited on the first catalyst 534.

In one example, first catalyst 534 includes a photocatalyst. In another example, first catalyst 534 includes titanium dioxide. Third reactor 530 may further include a radiation source. UV-A radiation may be applied using a high pressure mercury lamp. For example, visible UV-A radiation may be applied with a 100 W to 150 W high pressure mercury lamp. The third reactor 530 may utilize an inlet gas. In one example, the gas includes one or more of nitrogen gas, argon gas, and carbon dioxide gas. In one example, the flow rate of gas ranges from about 0.1 L/min to about 1 L/min. In another example, the flow rate of gas ranges from about 0.2 L/min to about 0.5 L/min. Importantly, this gas flow can prevent and/or reduce reactions between dissolved oxygen and photogenerated electrons. Third reactor 530 may utilize an acid for decreasing the pH value of the pH adjusted liquid. In one example, formic acid is added to third reactor 530. Third reactor 530 may decrease the pH value of the pH adjusted liquid to below about 6 pH, below about 5 pH, or below about 4 pH. In one example, third reactor 530 is capable of decreasing the pH value of the pH adjusted liquid to about 4 pH.

The copper deposited on the first catalyst 534 may be separated in a subsequent reactor by dissolving the first catalyst 534 at a pH value below about 6.3 pH. In this downstream reactor, the copper deposited on the first catalyst 534 may be contacted with a solution in an annular glass batch reactor equipped with a stirring system. Airflow may be introduced for oxidizing zerovalent copper to copper (II). In one non-limiting example, this downstream reactor separates copper from a titanium dioxide catalyst. Copper may be separated from titanium dioxide at a pH value from about 3 pH to about 5 pH. This reactor is capable of operating at environmental temperatures, such as about 18° C. to about 30° C. Accordingly, this downstream reactor may effectively recover Cu²⁺ in a solution.

Fourth reactor 540 includes fourth reservoir 542, reducing agent 544, and second catalyst 546. Fourth reactor 540 may be an annular glass batch reactor equipped with a stirring system and/or cooling jacket. Fourth reservoir 542 may be a vessel for holding or partially containing one or more fluids. Fourth reactor 540 may receive the pH adjusted liquid from second reactor 520, and fourth reactor 540 is capable of reactive adsorption of palladium. In one non-limiting example, fourth reactor 540 is capable of producing a liquid phase including one or more non-adsorbed species, and a solid phase including palladium and the second catalyst 546. In one example, reducing agent 544 includes ethanol. In another example, second catalyst 546 includes zinc oxide.

Adsorption of palladium may be performed at a temperature ranging from about 18° C. to about 35° C. For example, adsorption of palladium may be performed at a temperature ranging from about 18° C. to about 25° C. The pH adjusted liquid may be stirred at a rate ranging from 200 rpm to 1000 rpm. For example, the pH adjusted liquid may be stirred at a rate ranging from about 400 rpm to about 600 rpm. The reaction may be performed using an annular glass batch reactor equipped with a stirring system and a cooling jacket. The reaction may be performed under dark conditions, such as without the use of UV-A radiation. Importantly, if silver is present in the metal combination, the reactive adsorption of palladium can be performed under dark conditions to prevent or reduce the simultaneous reduction of silver on the second catalyst.

The palladium deposited on the second catalyst 546 may be separated in a subsequent reactor by dissolving the second catalyst 546 at a pH value below about 6.3 pH. This downstream reactor may include an annular glass batch reactor equipped with a stirring system. In this downstream reactor, the palladium deposited on the second catalyst 546 may be contacted with an acidic solution, such as a nitric acid solution, to separate the palladium. This reactor is capable of operating at environmental temperatures, such as about 18° C. to about 30° C. Accordingly, this downstream reactor can effectively recover metallic palladium.

Fifth reactor 550 includes fifth reservoir 552 and third catalyst 554. Fifth reactor 550 may be an annular glass batch reactor with a stirring system and a radiation source. Fifth reactor 550 may include a high-pressure mercury lamp in a sleeve. The sleeve may use water to maintain a constant temperature. Fifth reservoir 552 may be a vessel for holding or partially containing one or more fluids. Fifth reactor 550 is capable of effectively recovering silver from the non-adsorbed liquid product from fourth reactor 540. In one non-limiting example, fifth reactor 550 is capable of producing a liquid phase including a salt and ethanol solution, and a solid phase including metallic silver deposited on the third catalyst 554. In another example, the third catalyst 554 includes zinc oxide.

Photocatalytic deposition of silver on the third catalyst 554 may be performed at a temperature ranging from about 20° C. to about 40° C. In one example, photocatalytic deposition of silver on the third catalyst 554 may be performed at a temperature ranging from about 22° C. to about 30° C. In another example, photocatalytic deposition of silver on the third catalyst 554 may be performed at about 25° C. Photocatalytic deposition of silver on the third catalyst 554 may be performed at a pH value above about 7 pH. In one example, photocatalytic deposition of silver on the third catalyst 554 may be performed at a pH value ranging from about 7 pH to about 9 pH. In another example, photocatalytic deposition of silver on the third catalyst 554 may be performed at a pH value of about 8 pH. The reaction may be performed for at least 60 minutes, at least 90 minutes, or at least 120 minutes. This reaction may form a liquid phase including sodium chloride and ethanol, and a solid-phase including metallic silver deposited on the third catalyst 554.

The silver deposited on the third catalyst 554 may be separated in a subsequent reactor by dissolving the third catalyst 554 at a pH value below about 6.3 pH. This downstream reactor may include an annular glass batch reactor equipped with a stirring system. In this downstream reactor, the silver deposited on the third catalyst 554 may be contacted with an acidic solution, such as a nitric acid solution, to separate the silver from the third catalyst 554. This reactor is capable of operating at environmental temperatures, such as about 18° C. to about 30° C. Accordingly, this downstream reactor effectively separates metallic silver.

Importantly, method 400 and system 500 may be used to effectively separate two or more metals in a metal combination, such as metals in electrodes, batteries, catalysts, and electronics. These methods and systems utilize mild chemicals, temperatures, and pressures for recovering desired product metals. Further, the instant disclosure provides various embodiments for tuning the reactors according to the starting composition of the metal combination. By using this process, waste metals are recycled with high selectivity for reuse in additional products and applications.

### Example 1-Metal Recovery from Metal Combinations

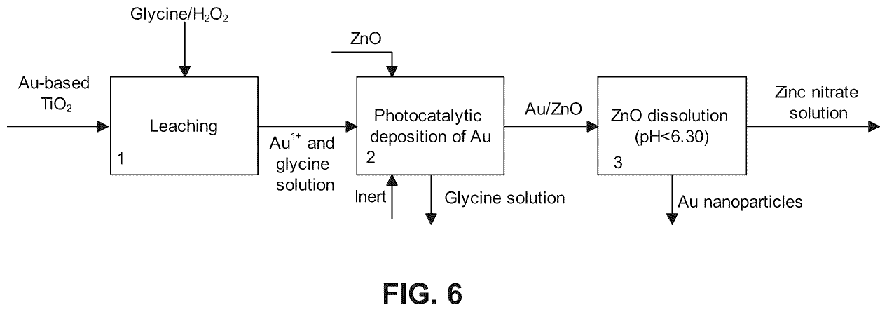

FIG. 6 illustrates a non-limiting method for recovering gold from a metal combination, according to some embodiments. Specifically, the recovery of gold from a spent gold-containing catalyst was performed. The tested gold-containing catalyst was an Au—TiO₂ catalyst, and 10 wt. % gold was deposited on the TiO₂ surface. The catalyst was contacted with a leaching solution including chloride ions, and subsequently the gold was contacted with glycine and hydrogen peroxide. After the extraction of the gold from the spent catalyst (unit 1), as Au(I) ions, the liquid solution can be treated through a photocatalytic process (unit 2) in the presence of ZnO as a photocatalyst, at a pH value higher than 6.3. The obtained material (i.e., Au/ZnO), was treated to obtain metallic gold nanoparticles through a slight acidification at a pH lower than 6.3 (unit 3). Obtaining metallic gold nanoparticles included dissolution of ZnO.

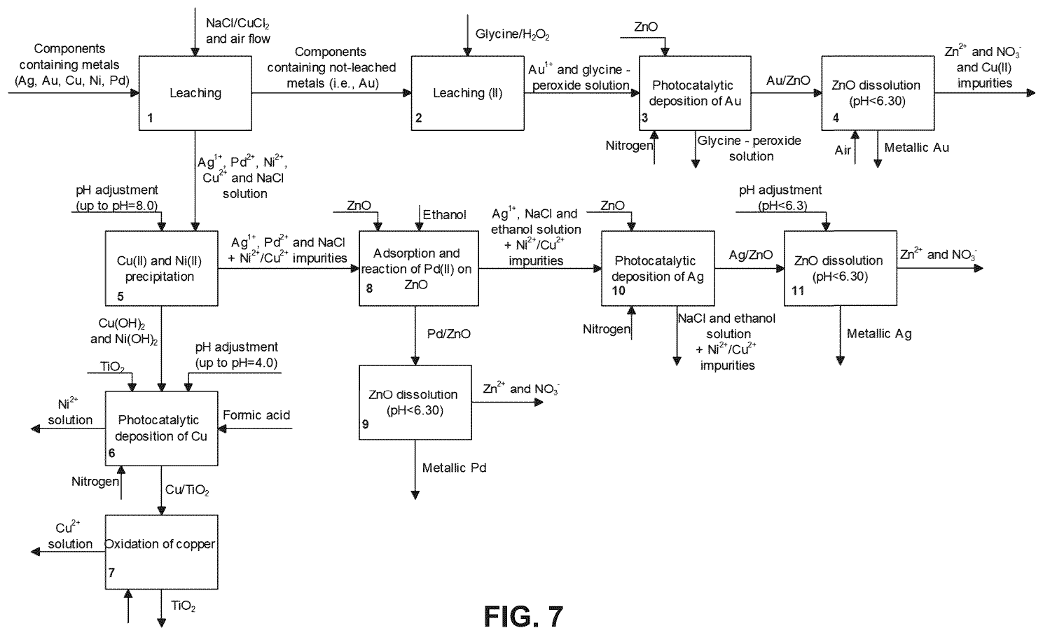

FIG. 7 illustrates a non-limiting method for selectively separating metals from a metal combination, according to some embodiments. The method in FIG. 7 includes one or more of the following steps (with various orders possible):

At unit 1, the metal combination (or metal-containing mixture) is placed in a water solution in which NaCl (6 M) and CuCl₂ (1-10 mM) are present, where the leaching process takes place. The reactor used in this section is an annular glass batch reactor equipped with a magnetic stirrer and cooling (or heating) jacket, and the stirring rate of the solution is set at 500 rpm, while the temperature of the system is set at 60° C. The pH of the solution is set at 4.0 or 5.0, depending on the metal involved in the recovery process, and the reaction is carried out for 120 minutes. An air flux (≈0.3 L/min) is flowed to improve the oxidation of the metals, and at the end of the leaching process, two different phases can be distinguished: (i) a liquid phase including the oxidized species, along with the leaching solution, and (ii) a solid phase, made of the non-oxidized metals (i.e., gold, if present).

At unit 2, the solid phase, mainly including gold, is transferred to a second leaching unit, and the material is placed in a water solution including glycine (0.1-1 M) and hydrogen peroxide (≈0.65 M), in which the leaching reaction takes place. The reactor used in this section is an annular glass batch reactor equipped with a magnetic stirrer and cooling (or heating jacket), and the solution is stirred at 500 rpm, while the temperature of the system is set to 60° C. The pH of the solution is adjusted to 12.8, and the reaction is carried out for 180 minutes. At the end of the process, the solution includes Au(I) ions and glycine, which can be transferred to the photodeposition unit (unit 3).

At unit 3, the photodeposition process takes place. The reactor used in this section is an annular glass batch reactor equipped with a magnetic stirrer and a high-pressure mercury lamp located in a quartz sleeve, in which water is used to maintain a constant temperature. The mixing of the solution is set at 500 rpm, while the temperature of the system is set at 25° C. The photocatalyst is ZnO, and nitrogen gas (or Argon or CO₂) is flowed (Q=0.3 l/min) to prevent any reaction between dissolved oxygen and photogenerated electrons. Surprisingly, zinc oxide may be used in the present disclosure even though zinc oxide is not typically stable at low pH values. The pH of the solution is set at 8.0, and a high pressure mercury lamp (UV-A-Visible, 125 W) can be used as a radiation source. Alternatively, the process can be carried out under solar radiation, by using the UV component of the solar spectrum. The reaction is carried out for 120 minutes. At the end of the process, two different phases can be identified: (i) a liquid phase including non-reacted glycine, and (ii) a solid phase, made of metallic Au deposited on ZnO. The solid phase is transferred to unit 4.

At unit 4, the effective recovery of gold is carried out. The solid phase is placed in a water solution at a pH lower than 6.3, at which ZnO nanoparticles can dissolve. The reactor used in this section is an annular glass batch reactor equipped with a magnetic stirrer and cooling jacket. Environmental temperature is used in this section, and the stirring rate is set at 500 rpm. An air flux (≈0.3 L/min) is flowed to carry out the oxidation of the copper eventually deposited on ZnO. Based on the purity of the spent zinc nitrate solution obtained, the recycling of this stream can prepare the photocatalytic material (i.e., ZnO). Accordingly, unit 4 produces separated metallic gold.

The liquid phase coming from unit 1, including the leaching solution and the leached metals (Ag(I), Pd(II), Ni(II), Cu(II)), undergoes a pH adjustment at unit 5, up to 8.0, in order to achieve the precipitation of some metal ions (i.e., nickel and copper) in the form of hydroxides. The reactor used in this section is an annular glass batch reactor equipped with a magnetic stirrer and cooling jacket, and environmental temperature is used in this section. The stirring rate is set at 500 rpm, and the pH is adjusted using a sodium hydroxide solution. At the end of the process, two different phases can be produced: (i) a liquid phase including the non-precipitated species (Ag(I), Pd(II), NaCl solution), and (ii) a precipitate, made of Cu(OH)₂ and Ni(OH)₂. The produced hydroxides are then transferred to unit 6.

At unit 6, the solid phase is poured in a formic acid (or ethanol or glycerol) solution (1 M), in which the pH was previously adjusted to 4.0 to dissolve copper species. In this section, TiO₂ (500 ppm) is used as a photocatalyst. The reactor used in this section is an annular glass batch reactor equipped with a magnetic stirrer and a high-pressure mercury lamp located in a quartz sleeve, in which water is used to keep a constant temperature. The mixing of the solution is set at 500 rpm, while a temperature of 25° C. is kept in the system. Nitrogen gas (or Argon or CO₂) is flowed (Q=0.3 l/min) to prevent or reduce any reaction between dissolved oxygen and photogenerated electrons. The pH of the solution is set at 4.0, and a high-pressure mercury lamp (UV-A-Visible, 125 W) can be used as a radiation source. Alternatively, the process can be carried out under solar radiation, by using the UV-component of the solar spectrum. The reaction is carried out for 60 minutes. At the end of the process, two different phases can be identified: (i) a liquid phase including Ni(II), and (ii) a solid phase, mainly including metallic copper deposited on TiO₂.

At unit 7, the solid phase including metal deposited on TiO₂ is placed in a solution at pH=4.0, in which an airflow enables the oxidation of zerovalent copper to copper (II), which can be separated from TiO₂. The reactor used in this section is an annular glass batch reactor equipped with a magnetic stirrer and cooling. Environmental temperature is used in this section. The stirring rate is set at 500 rpm, and air flows in the system (Q=0.3 l/min) for oxidation. The process is carried out for 60-120 minutes, based on metal concentration.

At unit 8, the liquid phase-outstream from unit 5-mainly including the leaching solution along with the leached metals which did not precipitate (Ag(I), Pd(II) and some impurities of Cu(II) and Ni(II)), is transferred to unit 8, in which the reactive adsorption of palladium, under dark conditions, is carried out in the presence of ZnO (500 ppm) and ethanol (1 M). The reactor used in this section is an annular glass batch reactor equipped with a magnetic stirrer and cooling jacket. Environmental temperature is used in this section. The stirring rate is set at 500 rpm, and the process is carried out under dark conditions, to prevent the simultaneous reduction of silver on ZnO. At the end of the process, two different phases can be formed: (i) a liquid phase including the non-adsorbed species (Ag(I) and NaCl solution), and (ii) a solid phase composed of Pd/ZnO. The solid phase can be transferred to unit 9.

At unit 9, the effective recovery of palladium is accomplished. The solid phase is placed in a water solution at a pH lower than 6.30 to dissolve ZnO nanoparticles. The reactor used in this section is an annular glass batch reactor equipped with a magnetic stirrer and cooling jacket. Environmental temperature is used in this section, and the stirring rate is set at 500 rpm. The adjustment of pH is carried out by means of an HNO₃ solution. Based on the purity of the spent zinc nitrate solution obtained, the recycling of this stream can be used to synthesize a fresh photocatalytic material (i.e., ZnO).

At unit 10, the effective recovery of silver is obtained from the liquid product of unit 8. The reactor used in this section is an annular glass batch reactor equipped with a magnetic stirrer and a high-pressure mercury lamp located in a quartz sleeve, in which water is used to maintain a constant temperature. The mixing of the solution is set at 500 rpm, while the temperature of the system is kept at 25° C. The used photocatalyst is commercial ZnO. Nitrogen gas (or Argon or CO₂) is flowed (Q=0.3 l/min) to prevent any reaction between dissolved oxygen and photogenerated electrons. The pH of the solution is set at 8.0, and a high-pressure mercury lamp (UV-A-Visible, 125 W) can be used as a radiation source. Alternatively, the process can be carried out under solar radiation, by using the UV-component of the solar spectrum. The reaction is carried out for 120 minutes. At the end of the process, two different phases can be identified: (i) a liquid phase mainly including NaCl and ethanol solution, and (ii) a solid phase, including metallic Ag deposited on ZnO. The solid phase can be transferred to unit 11.

At unit 11, the effective recovery of silver is carried out. The solid phase is placed in a water solution at a pH lower than 6.30 to dissolve ZnO nanoparticles. The reactor used in this section is an annular glass batch reactor equipped with a magnetic stirrer and cooling jacket. Environmental temperature is used in this section, and the stirring rate is set at 500 rpm. The adjustment of pH is carried out by means of an HNO₃ solution. Based on the purity of the spent zinc nitrate solution obtained, the recycling of this stream can be used to prepare a fresh photocatalytic material (i.e., ZnO). Accordingly, unit 11 effectively recovers metallic silver from the metal combination.

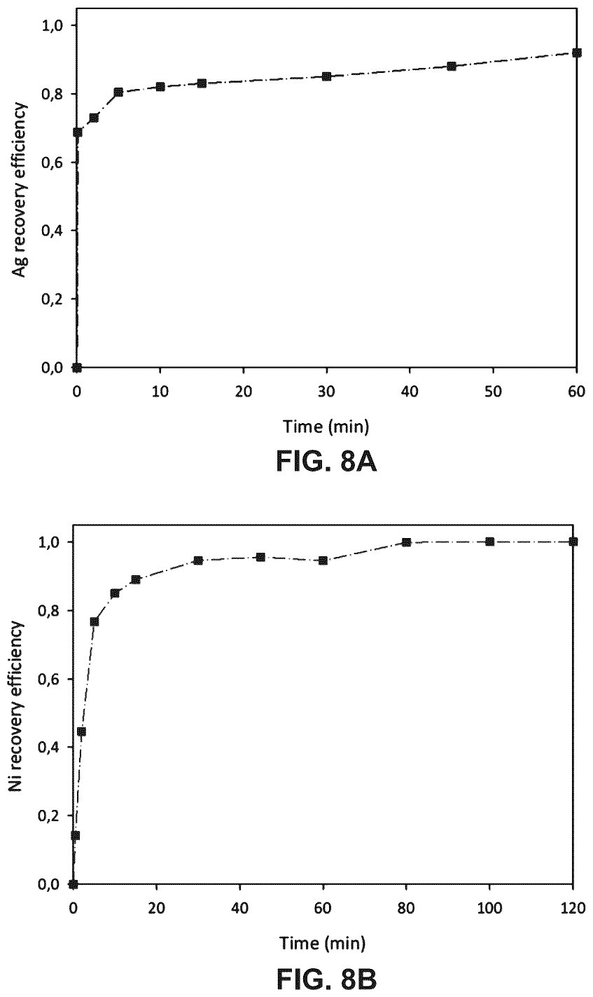

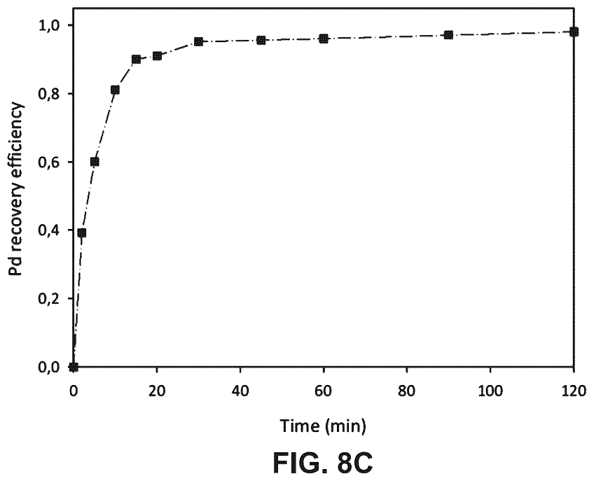

FIG. 8A illustrates the metal dissolution efficiency for silver, according to some embodiments. For FIG. 8A, the experimental conditions were as follows: [Ag]=1 mM; [CuCl₂]=5 mM; [NaCl]=6 M; pH=5.0; and T=60° C. FIG. 8B illustrates the metal dissolution efficiency for nickel, according to some embodiments. For FIG. 8B, the experimental conditions were as follows: [Ni]=1 mM; [CuCl₂]=5 mM; [NaCl]=6 M; pH=5.0; and T=60° C. FIG. 8C illustrates the metal dissolution efficiency for palladium, according to some embodiments. For FIG. 8C, the experimental conditions were as follows: [Pd]=1 mM; [CuCl₂]=2.5 mM; [NaCl]=6 M; pH=5.0; and T=60° C.

As illustrated in FIGS. 8A-8C, a total dissolution of silver, nickel and palladium was observed after 60, 120 and 30 minutes, respectively, when a leaching solution including fixed concentrations of CuCl₂ and NaCl is used at a pH set at 5.0 and a temperature of 60° C. Importantly, the leaching solution did not dissolve gold. Reactions involved in the process are shown in Equations 1-4 below.

Ni⁰+2Cu²⁺+6 Cl⁻↔NiCl⁺+CuCl₂⁻CuCl₃²⁻ (1)

Pd⁰+2Cu²⁺+4 Cl⁻↔PdCl₂⁻+CuCl₂⁻ (2)

Ag⁰+Cu²⁺+4 Cl⁻↔AgCl₂⁻+CuCl₂⁻ (3)

Cu⁰+Cu²⁺+6 Cl⁻↔2CuCl₃⁻+CuCl₂⁻ (4)

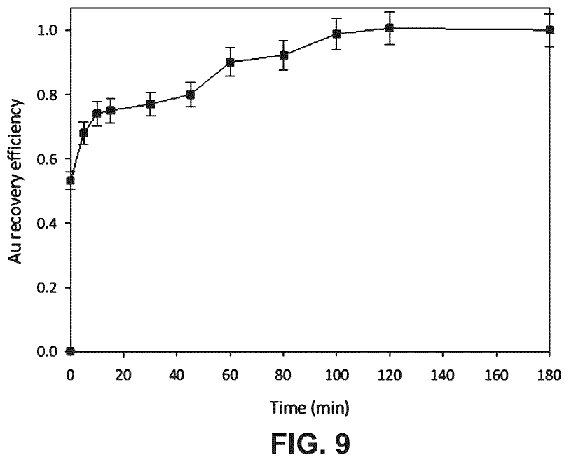

FIG. 9 illustrates the gold dissolution efficiency in the presence of glycine, according to some embodiments. For FIG. 9, the experimental conditions were as follows: [Au(0)]=0.12 mM; [Glycine]=1 M; [H₂O₂]=2 wt. %; pH=12.8; and T=60° C. As shown, in the presence of glycine and hydrogen peroxide, about 80% of gold was dissolved after 60 minutes of reaction when pure metallic powder was used as a starting material. Total dissolution was observed after 100 minutes in these conditions.

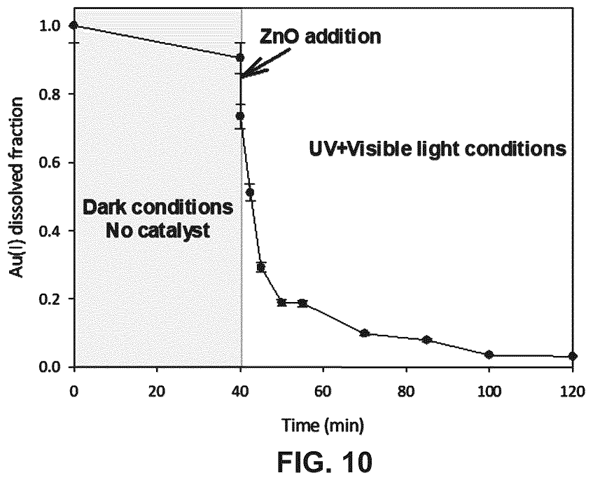

FIG. 10 illustrates evolution of the gold photodeposition on zinc oxide, according to some embodiments. As shown in FIG. 10, a slight decrease was also observed under dark conditions in the absence of ZnO, which may be due to the reducing properties of glycine in the presence of gold(I). The presence of glycine is useful not only to complex Au(I) ions—avoiding the precipitation of this species—but is also able to improve the reduction of the cation to its metallic form.

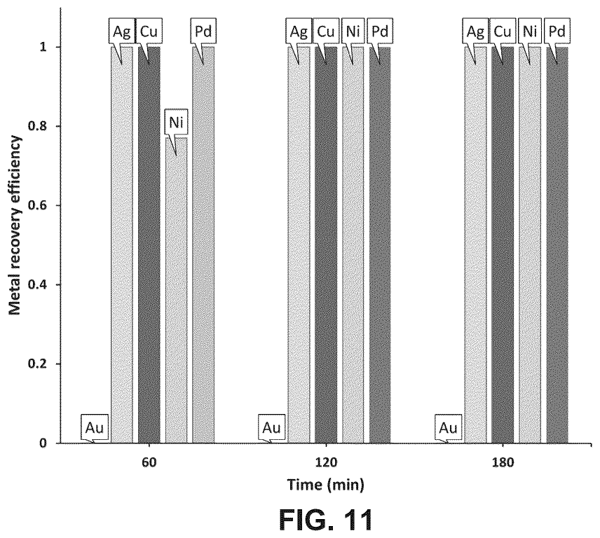

FIG. 11 illustrates metal recovery efficiency under mild acidic conditions, according to some embodiments. The amount of each metal was chosen based on the typical composition of electronic waste. Specifically, the metals of interest, of random-access memory (RAM), were (total amount=300 mg): Copper=95-98 wt. %; Nickel=1-4 wt. %; Silver=0.1-0.5 wt. %; Gold=0.04-0.13 wt. %; and Palladium=0.004-0.008 wt. %. The mixture was treated with a leaching solution (FIG. 7—unit 1) (V=0.3 L, [NaCl]=6 M and [CuCl₂]=10 mM) at a temperature of 60° C. In this case, the pH of the solution was 4.0, to avoid the precipitation of copper ions involved in the process. An air flux (≈0.3 L/min) was provided to improve the oxidation of the metals. As shown, the total dissolution of the metals, except for gold, was achieved after 120 minutes of reaction.

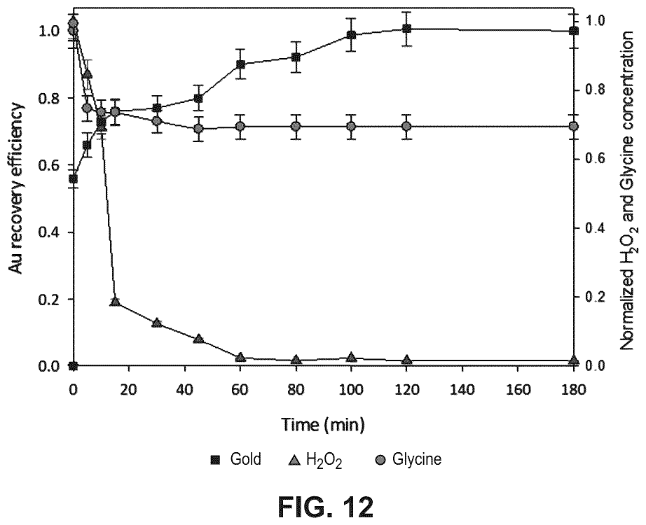

FIG. 12 illustrates gold (Au) dissolution efficiency, evolution of hydrogen peroxide (H₂O₂), and evolution of glycine (C₂H₅NO₂), according to some embodiments. At the end of the leaching process, the solid phase, mainly including the not dissolved gold, was treated (FIG. 7—unit 2) in the presence of glycine (1 M), and hydrogen peroxide (2 wt. %, 0.66 M), at a temperature of 60° C. and a pH set at 12.8. In these conditions, a total dissolution of gold was obtained. Glycine and hydrogen peroxide were used as complexing and oxidizing agents, respectively. As shown, a moderate decrease of glycine was detected with time, which may be due to the oxidation of the organic compound in the presence of H₂O₂, which is almost completely degraded within 60 minutes.

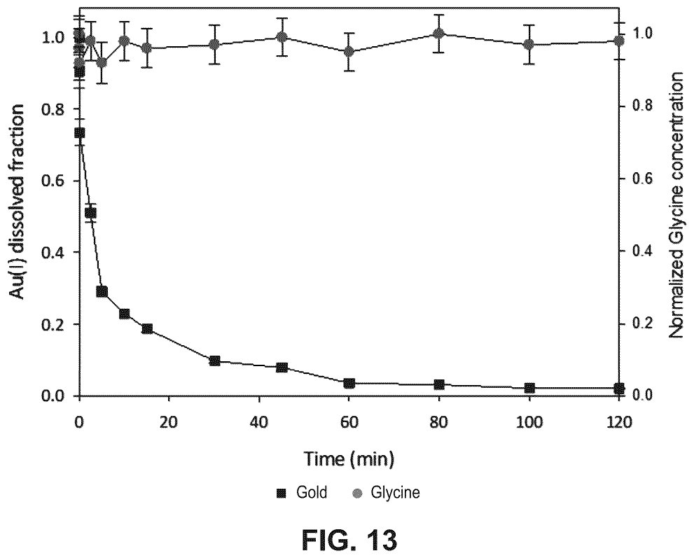

FIG. 13 illustrates evolution of gold photodeposition on zinc oxide, according to some embodiments. At the end of the process, the nitrogen gas flowed for 40 minutes in the solution mainly composed of gold (I), glycine and a small amount of hydrogen peroxide eventually not degraded during the leaching process (FIG. 7—unit 3); the pH was adjusted to 8.0, and a fixed amount of ZnO (500 ppm) was added. Under UV-A radiation, gold was deposited on the ZnO photocatalyst (FIG. 7—unit 3) after 120 minutes. In this case, a negligible reduction in the concentration of glycine was observed during the experiment, due to the great amount of scavenger (i.e., glycine) with respect to gold in this process. After photodeposition, the solid phase obtained at the end of unit (3) was transferred to an aqueous solution for the pH adjustment at a value lower than 6.3 (pH≈5). In this way, metallic gold was obtained.

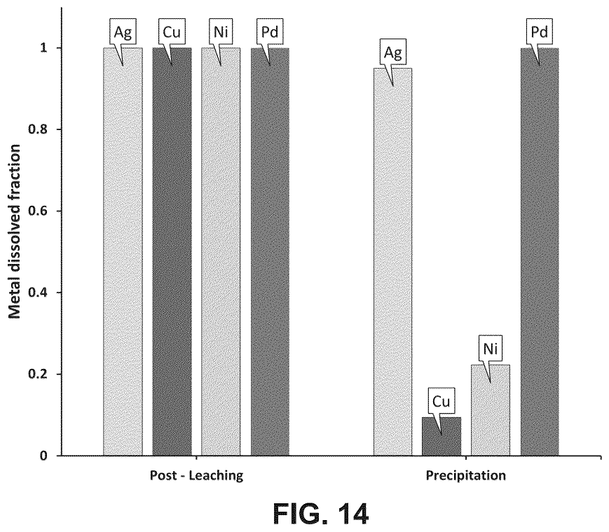

FIG. 14 illustrates metal dissolved fraction before and after pH adjustment, according to some embodiments. At the end of the leaching process (FIG. 7—unit 1) the liquid phase, mainly including silver, copper, nickel, and palladium ions, along with the leaching solution, was treated (FIG. 7—unit 5) by adjusting the pH of the solution up to 8.0. As shown, when the pH of the solution is 8.0, about 95% of copper precipitates as Cu(OH)₂, along with 80% of nickel as Ni(OH)₂.

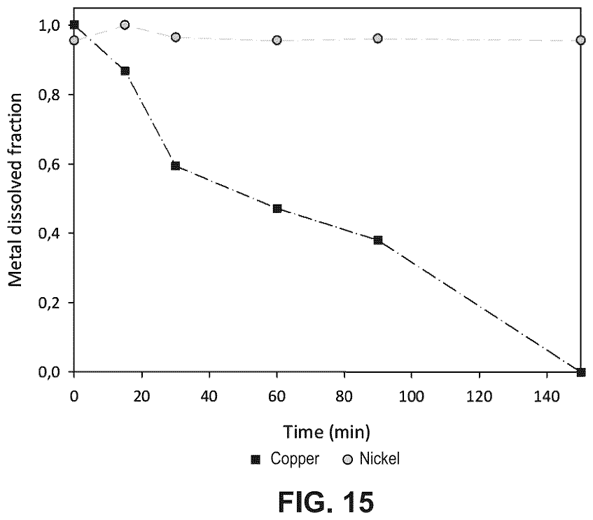

FIG. 15 illustrates evolution of nickel and copper photodeposition on titanium dioxide, according to some embodiments. The solid phase, mainly including hydroxides, was poured in a formic acid solution at a pH set at 4.0, along with TiO₂ (500 ppm), which is used as photocatalyst (FIG. 7—unit 6). Nitrogen gas was flowed (Q=0.3 l/min) to prevent the reaction between dissolved oxygen and photogenerated electrons. At the end of the process, the liquid phase mainly included nickel (II) solution, while the solid phase, Cu/TiO₂ suspension was treated, in an aqueous solution (FIG. 7—unit 7), with an airflow for about 10 minutes. In this way, the total oxidation of copper was obtained.

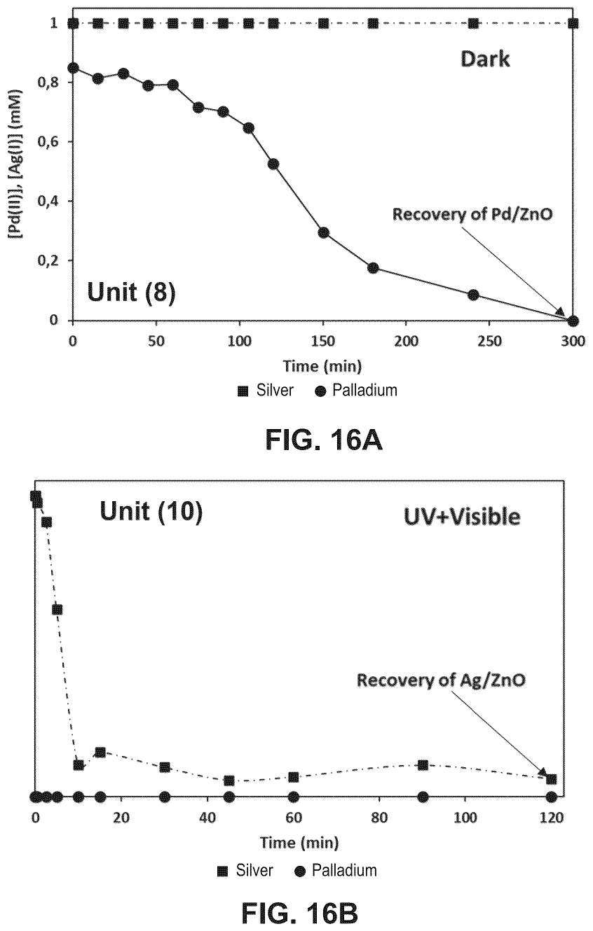

FIG. 16A illustrates selective palladium deposition, according to some embodiments. FIG. 16B illustrates selective silver deposition, according to some embodiments. Palladium is represented by circles, and silver is represented by squares. The experimental conditions were as follows: pH=8; T=25° C.; [EtOH]=1 M; Dark: C_{ZnO}=500 ppm; and UV+Visible: C_{ZnO}=500 ppm. The liquid solution coming from unit 5 (FIG. 7) mainly includes Ag(I), Pd(II), NaCl, and some impurities of copper and nickel; it is firstly treated (FIG. 7—unit 8) through adsorption of palladium in the presence of ZnO (500 ppm) and ethanol (1 M) under dark conditions, then the liquid phase, including mainly Ag (I), NaCl and ethanol, is treated through a photocatalytic process in the presence of ZnO (500 ppm) (FIG. 7—unit 10). As clearly indicated by the diagram, the total recovery of both metals was obtained in the two different steps.

### Example 2-Ni-Based Multilayer Ceramic Capacitors (MLCC)

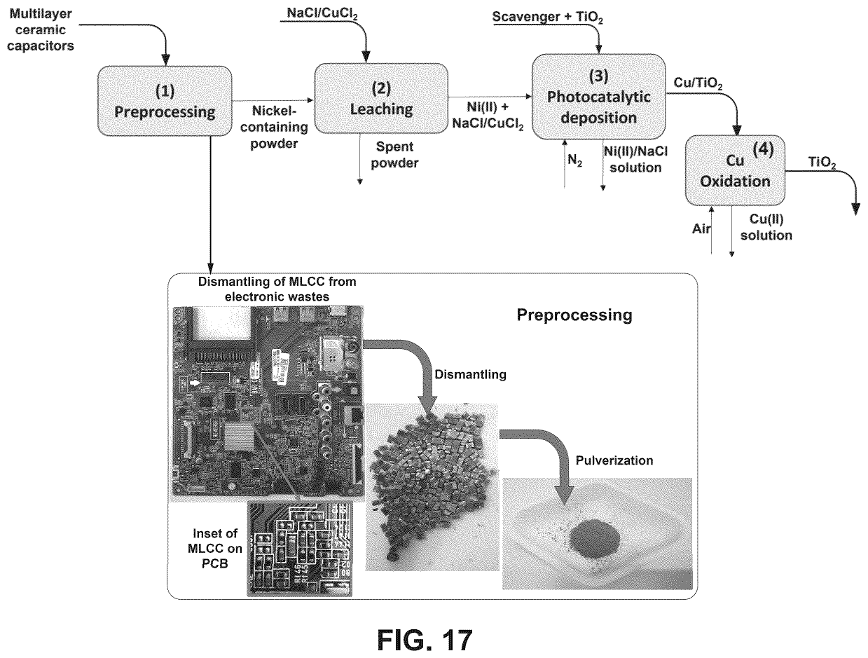

FIG. 17 illustrates pre-processing of electronic wastes and recovering metals, according to some embodiments. The schematic of the proposed process for metal recovery is adapted for the selective recovery of nickel (Ni) from of the exhausted Ni-MLCC. In this case, a pre-processing unit, in which the components located on different PCBs were separated from the e-waste (dismantling) and subsequently pulverized, is provided. Then, the leaching solution including NaCl/CuCl₂ (FIG. 7—unit 1) is used to oxidize Ni(0) to Ni(II), originating two different phases: a liquid phase, mainly including Ni(II) and the leaching solution, and a solid phase, which mainly includes the not-leached component. The solution derived from the leaching unit is successively treated, in the presence of TiO₂ nanoparticles in a photocatalytic reactor (FIG. 7—unit 6). In particular, the photodeposition process takes place in the presence of a scavenger, under UV-A/visible light radiation. The liquid phase includes the not photodeposited species (Ni(II) and NaCl), while the solid phase is represented by a Cu/TiO₂ material, which can be treated with an air flux, able to oxidize the copper species, thus obtaining the separation of the metal (copper), from the catalyst (FIG. 7—unit 7).

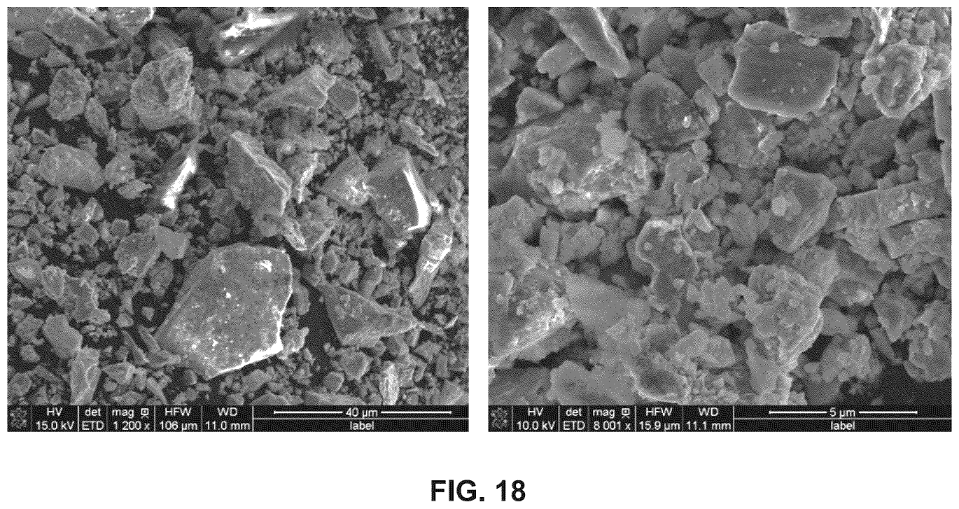

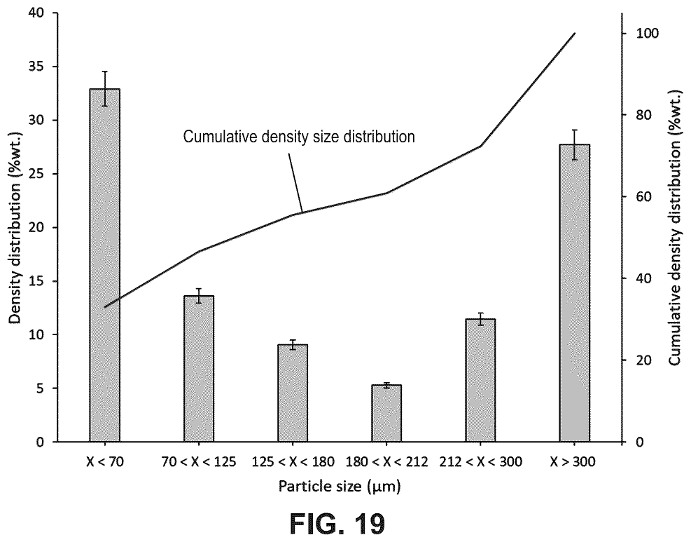

FIG. 18 illustrates scanning electron microscope (SEM) images of pulverized Ni-based multilayer ceramic capacitors (MLCC), according to some embodiments. FIG. 19 illustrates particle size distribution of spent Ni-MLCC, according to some embodiments. As indicated in the figures, a wide size distribution was observed in this case. The particle size distribution was evaluated: about 33% wt. of the pulverized matrix includes particles smaller than 70 μm, while 28 wt. % is made of larger particles (>300 μm).

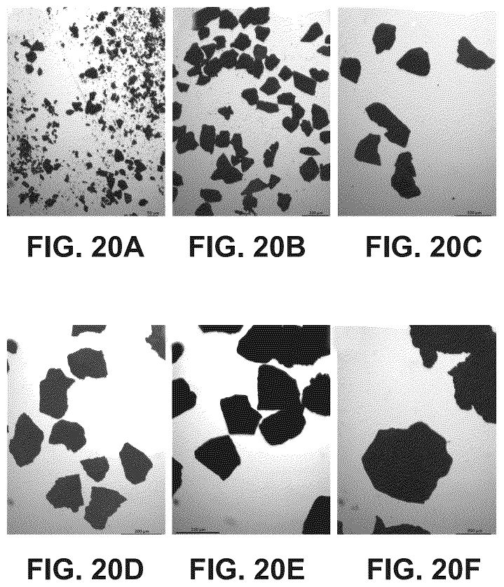

FIG. 20A illustrates optical microscope images of solid particles at a particle dimension (μm) less than 70, according to some embodiments. FIG. 20B illustrates optical microscope images of solid particles at a particle dimension (μm) between 70 and 125, according to some embodiments. FIG. 20C illustrates optical microscope images of solid particles at a particle dimension (μm) between 125 and 180, according to some embodiments. FIG. 20D illustrates optical microscope images of solid particles at a particle dimension (μm) between 180 and 212, according to some embodiments. FIG. 20E illustrates optical microscope images of solid particles at a particle dimension (μm) between 212 and 300, according to some embodiments. FIG. 20F illustrates optical microscope images of solid particles at a particle dimension (μm) greater than 300, according to some embodiments. The metal composition of Ni-MLCC is shown in Table 1 below. Accordingly, a metal combination may include one or more of Ba, Ca, Cu, Ni, Sn, Ti, Ag, Zn, Bi, and Pt.

TABLE 1
Metal composition of Ni-MLCC (wt. %)

| | | | | | | | | Acid |
|---|---|---|---|---|---|---|---|---|
| Element | Ba | Ca | Cu | Ni | Sn | Ti | Other* | Insoluble** |
| wt. % | 41.81 | 1.55 | 4.03 | 20.4 | 3.36 | 18.65 | 2.73 | 7.47 |

*Other corresponds to the sum of all metals present in percentage with a composition lower than 1 wt. % (i.e., Ag, Zn, Bi, Pt).
**Acid Insoluble represents the fraction of MLCC insoluble in acid.

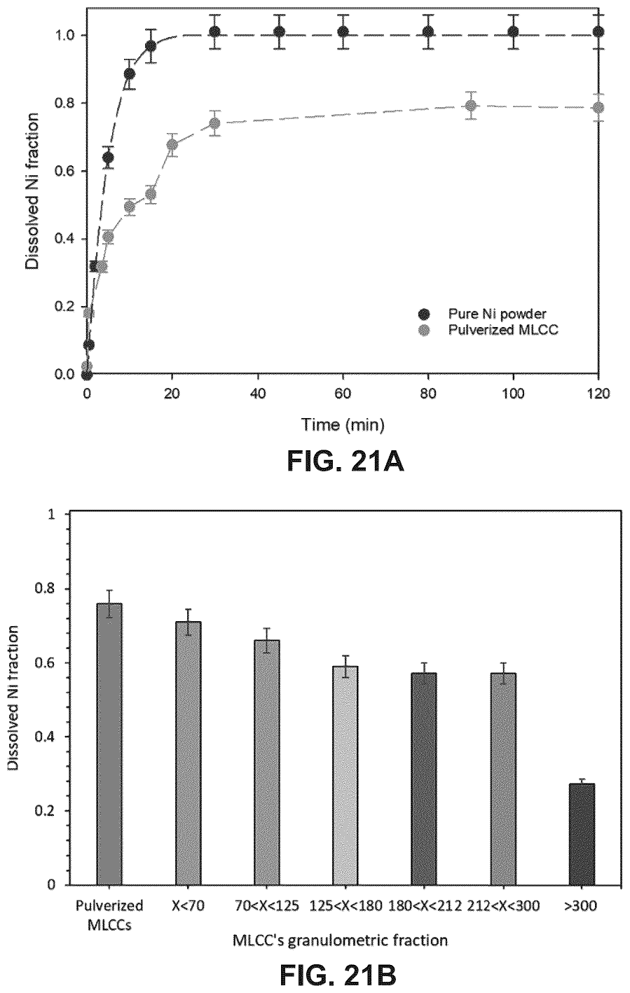

FIG. 21A illustrates dissolved nickel fraction against time from pure Ni powders and pulverized MLCCs, according to some embodiments. FIG. 21B illustrates dissolved nickel fraction after 120 minutes from different MLCC granulometric fractions, according to some embodiments. The experimental conditions were as follows: Pure Ni powder amount=21 mg (MLCCs powder amount=60 mg); [NaCl]₀=6.0 M; [Cu(II)]₀=5.0·10⁻³ M; V=200 mL; T=60° C.; and pH≈4.5.

### Example 3-Recovery of Gold from Spent Catalysts

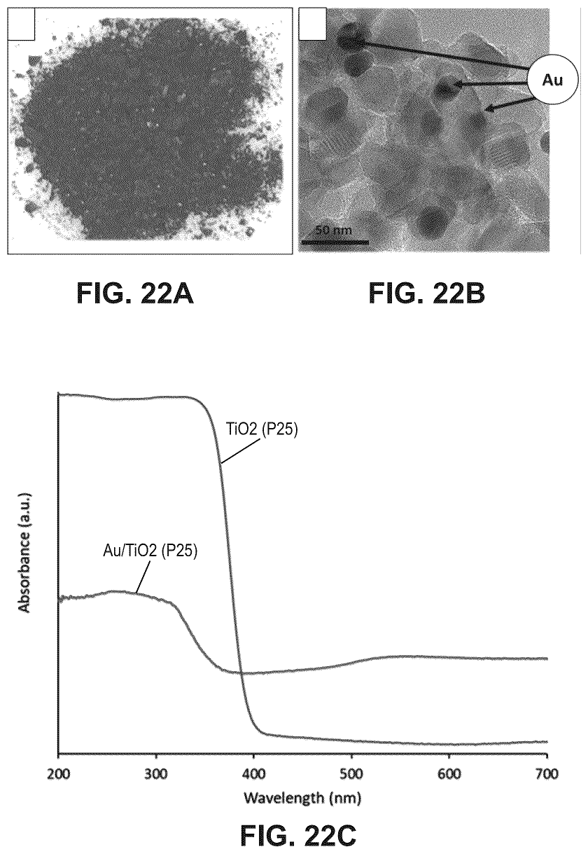

FIG. 22A illustrates an image of a spent Au/TiO₂ catalyst, according to some embodiments. The spent catalyst (with a nominal amount of Au of 10 wt. % with respect to TiO₂ (confirmed by SEM-EDX analysis) was prepared through photodeposition and was used several times for photocatalytic hydrogen production process in the presence of different organic compounds as sacrificial agents.

FIG. 22B illustrates a transmission electron microscope (TEM) of Au/TiO₂ catalyst, according to some embodiments. As shown in the TEM image of the spent powder, gold nanoparticles (diameter ranging between 10-20 nm) were mostly uniformly distributed on the TiO₂ surface. FIG. 22C illustrates UV-Vis diffuse reflectance absorbance spectra of TiO₂ and Au/TiO₂ catalysts, according to some embodiments. Moreover, by measuring the optical properties of the material through the UV-Vis diffuse reflectance absorbance spectrum, the Au-doped TiO₂ sample demonstrated higher absorbance intensity than bare titanium dioxide. The presence of Au metal improved the absorbance spectra towards visible range due to their optical absorption spectra ranging between 500 and 700 nm, related to the surface plasmon resonance absorption effect.

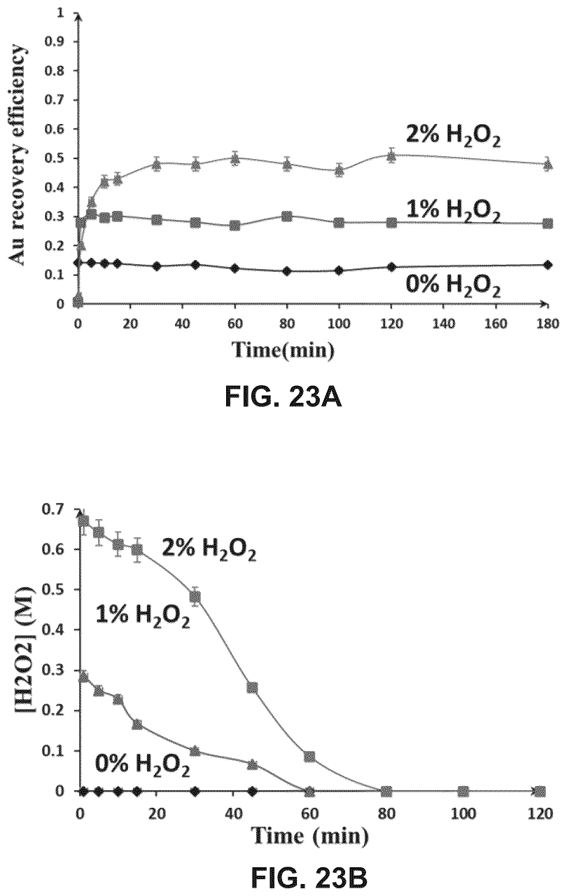

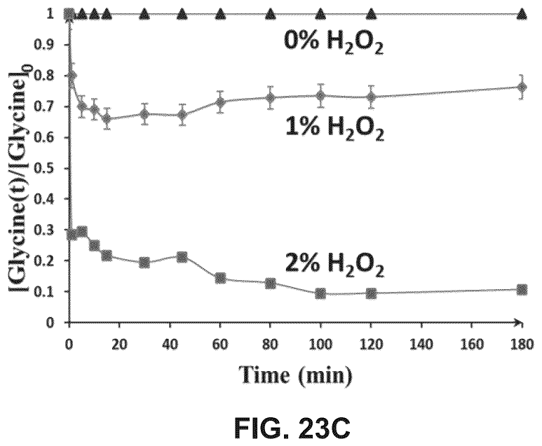

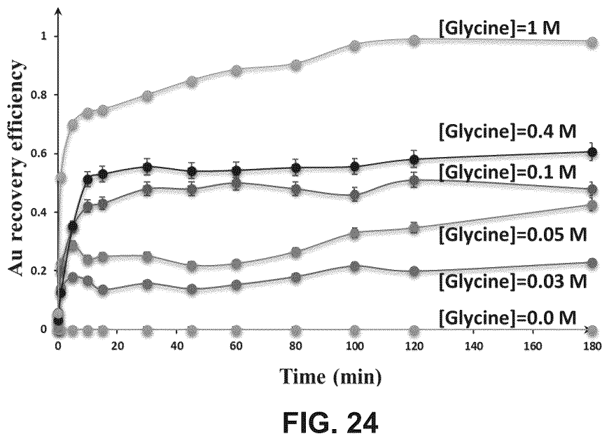

FIG. 23A illustrates gold dissolution efficiency during a leaching experiment at varying hydrogen peroxide initial concentrations, according to some embodiments. FIG. 23B illustrates evolution of hydrogen peroxide during a leaching experiment at varying hydrogen peroxide initial concentrations, according to some embodiments. FIG. 23C illustrates evolution of glycine during a leaching experiment at varying hydrogen peroxide initial concentrations, according to some embodiments. Firstly, the concentration of H₂O₂ was varied between 0 and 2 wt. % (0-0.66 M). A 200 ml glycine (0.1 M) solution was prepared in the presence of 50 mg of Au-based TiO₂ photocatalyst (≈5 mg of Au). As shown, upon increasing the concentration of hydrogen peroxide in the solution, an improved Au oxidation efficiency was observed (FIG. 23A), obtaining 60% gold extraction in the presence of 2 wt. % (0.66 M) of H₂O₂. As for the glycine evolution (FIG. 23C), the oxidation of this organic compound can be greatly affected by the H₂O₂ concentration, obtaining 90% of degradation when 2 wt. % of H₂O₂ is used. A negligible H₂O₂ concentration was observed after the leaching process, as observed in the FIG. 23B. FIG. 24 illustrates gold dissolution efficiency during a leaching experiment with varying glycine initial concentrations, according to some embodiments. The effect of glycine concentration was evaluated, observing the total Au dissolution when 1 M of glycine was used in the system under alkaline conditions. This condition was used to carry out the process.

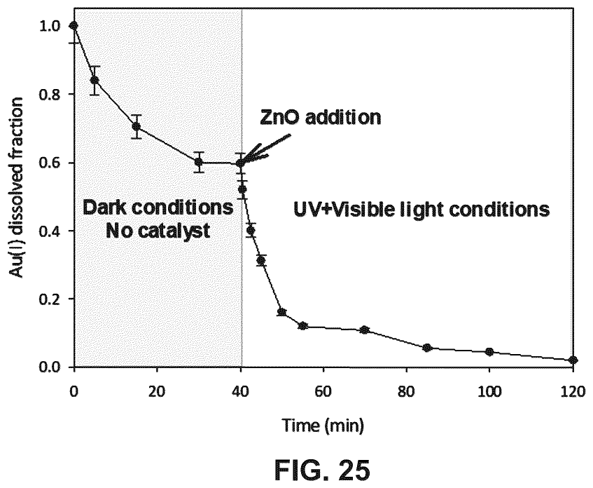

FIG. 25 illustrates evolution of gold photodeposition on ZnO under UV-A radiation, according to some embodiments. The solution from unit 1 (FIG. 6) was then treated in the presence of ZnO photocatalyst under UV+visible light radiation, after adjusting the pH between 7.0 and 8.0. The suspension included Au(I) (≈25 ppm), a certain amount of glycine not oxidized during the leaching process (about the 80% of the initial amount, considering FIG. 23C), H₂O₂ eventually not converted during the leaching run (approximately 0), and ZnO photocatalyst (500 ppm). After purging, under UV-A+Visible light radiation the complete Au photodeposition was obtained within 120 minutes of irradiation. Moreover, as shown in FIG. 25, a reduction of the metal occurred also under dark conditions, without the photocatalyst, due to the reducing effect exerted by glycine present in solution.

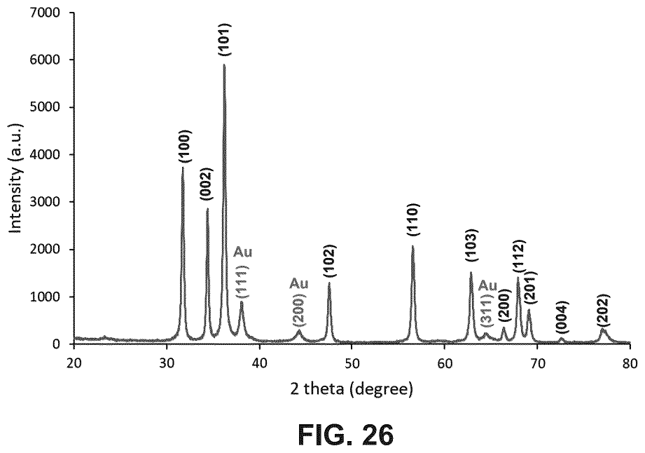

FIG. 26 illustrates an X-ray powder diffraction (XRD) pattern of gold deposited on ZnO, according to some embodiments. XRD patterns on the solid composite material (Au/ZnO), recovered at the end of the experimental run, confirmed the presence of metallic gold deposited on the ZnO surface. Finally, the effective recovery of gold was obtained through a slight acidification of the obtained material at a pH lower than 6.3.

### Example 4-Recovery of Palladium from Catalytic Converters

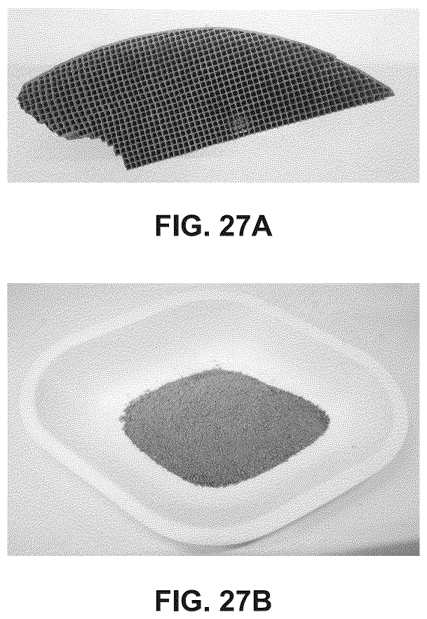

FIG. 27A illustrates a catalytic converter, according to some embodiments. FIG. 27B illustrates a catalytic converter after preprocessing, according to some embodiments. In this case, the analyzed catalytic converter was pulverized and characterized. Specifically, the used sample included ≈1.5 wt. % of Pd, ≈ 75 wt. % of Al₂O₃, and other metals, among which Si (≈13 wt. %) and Ce (≈3 wt. %) represent the largest part. In this case, 99% efficiency of palladium recovery was obtained when the leaching solution including NaCl/CuCl₂ is used at T=60° C. A 200 ml solution of NaCl (6 M) and CuCl₂ (2.5 mM) was used to treat 1 gr of catalyst powder. The obtained suspension was then filtered to remove the solid fraction including the not-leached metals, and the obtained solution included Pd(II) and the leaching solution. The solution may also contain impurities of other leached species.

### Example 5-Recovery of Silver from Electrodes

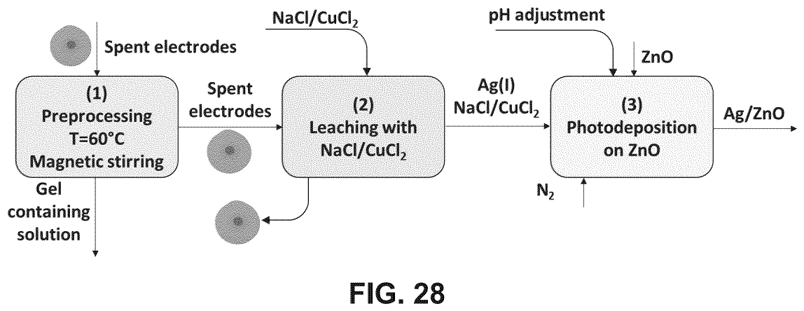

FIG. 28 illustrates a method of recovering silver from spent electrodes, according to some embodiments. Leaching experiments were carried out, both on the pure metal and on the real matrix; as for unit 2 of FIG. 28, in the case of the experiments on the synthetic matrix (pure metal), a fixed amount of metallic Ag (1 mM) was added to a deionized aqueous solution (V=200 ml) including fixed concentrations of CuCl₂ (1-8 mM) and sodium chloride (1-6 M), at certain temperatures (20-80° C.) and pH's (2-7). The suspension was agitated at 500 rpm to promote the suspension of particles and reduce liquid-solid mass transfer limitations in the leaching process. At different times, liquid samples were collected to evaluate Ag leaching efficiency. Software was used at this stage to optimize Ag extraction efficiency, by using a three-level, three-factorial Box-Behnken experimental design. The effect of the temperature T (A), pH (B), Cu(II) concentration (C) and Cl⁻ concentration (D) on the Ag leaching was evaluated at 3 different levels. The response of the system Y (Ag oxidation efficiency) can be expressed by the following polynomial function in Equation 5.

$$Y = {a}_{0} + {a}_{1} A + {a}_{2} B + {a}_{3} C + {a}_{4} D + {a}_{11} {A}^{2} + {a}_{22} {B}^{2} + {a}_{33} {C}^{2} + {a}_{44} {D}^{2} + {a}_{12} AB + {a}_{13} AC + {a}_{14} AD + {a}_{23} BC + {a}_{24} BD + {a}_{34} CD + ε \qquad ( 5 )$$

Where a₀ is the constant coefficient, aᵢ is the linear coefficient, aᵢᵢ is the second order coefficient, aᵢⱼ is the interaction coefficient between the factors (i.e., A, B, C, D), and ε is the error of the model. The analysis of variance (ANOVA) was used to analyse the experimental data. Response optimized was used, with 100% efficiency target, was used to identify the optimal experimental conditions.

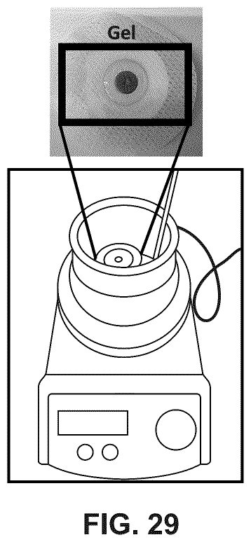

FIG. 29 illustrates gel removal from an electrode, according to some embodiments. Based on the results of the optimization procedure, some experiments were performed on the real matrix, by using a different number of electrodes (1-12), with different Ag concentrations in the resulting leaching solution (0.1-1 mM). Firstly, selected numbers of electrodes were treated at 60° C. for 30 minutes (unit 1 of FIG. 28), to remove the gel, then the as-obtained electrodes were inserted in a solution including a certain amount of CuCl₂ and NaCl, at a fixed pH and temperature (the experimental conditions in this case were obtained by the optimization procedures described herein). The leaching experiments were conducted for 2 hours, then the suspension was filtered to remove the solid phase from the Ag(I) including solution.

The leaching solution coming from the leaching unit, mainly including Ag(I), Cu(II) and NaCl solution, was first treated by increasing the pH of the solution up to 8.0, thus precipitating most part of copper as Cu(OH)₂. Then, the photocatalytic process (unit 3 of FIG. 28) was carried out. NaCl was used instead of ethanol as a scavenger in the presence of ZnO photocatalyst (500 ppm). Nitrogen was used to purge the system. Also in this case, the solid material was treated in a solution at a pH lower than 6.3 thus recovering the pure metallic Ag.

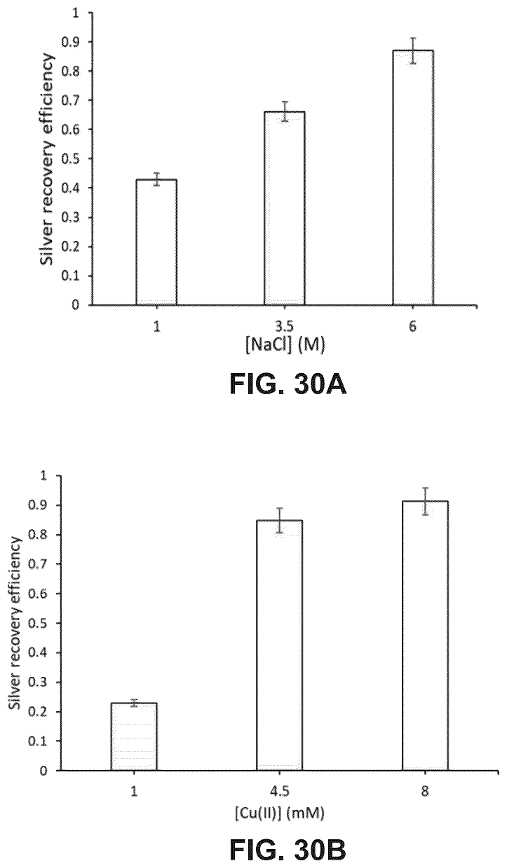

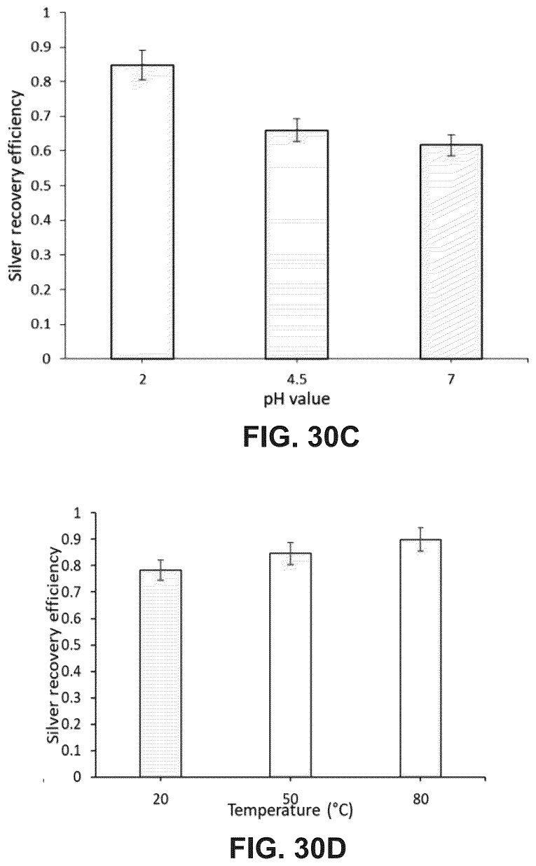

FIG. 30A illustrates the silver recovery efficiency based on chloride concentration (T=50° C., [Cu(II)]=4.5 mM; pH=4.5), according to some embodiments. FIG. 30B illustrates the silver recovery efficiency based on copper concentration (T=50° C., [NaCl]=3.5 M; pH=4.5), according to some embodiments. FIG. 30C illustrates the silver recovery efficiency based on pH value (T=50° C., [Cu(II)]=4.5 mM; [NaCl]=3.5 M), according to some embodiments. FIG. 30D illustrates the silver recovery efficiency based on temperature ([NaCl]=3.5 M; [Cu(II)]=4.5 mM; pH=4.5), according to some embodiments.

As observed in the case of nickel dissolution, upon decreasing the pH of the solution, an increased dissolution rate was observed, despite a similar efficiency was detected by reducing the pH from 4.5 to 2. The increase of Cu(II) and Cl ions concentration, enhances the Ag extraction efficiency, due to (i) the formation of chloro-complexes in the solution, (ii) the modification of the redox potential which improve Ag oxidation and (iii) the improvement of the oxidizing agent concentration. Finally, temperature affected the oxidation rate, observing Ag dissolution efficiencies higher than 90% when the temperature of the system was fixed to 80° C. Based on these results, it was possible to identify the conditions able to optimize the Ag recovery efficiency: by fixing as a target the maximum efficiency (η≈1), pH of the solution equal to 4.78, temperature T of 80° C., a cupric concentration equal to 8 mM and a NaCl concentration of 3.72 M can be used.

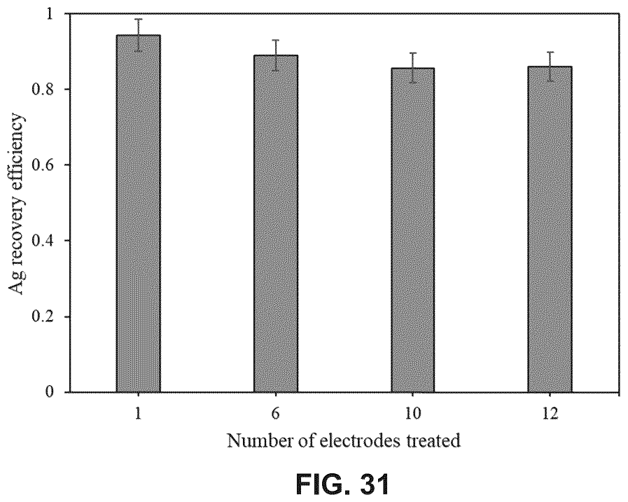

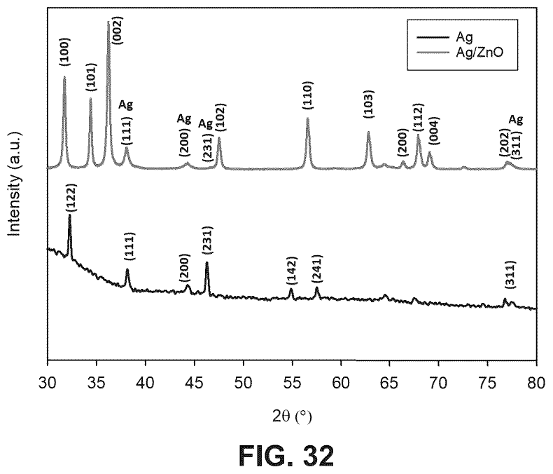

FIG. 31 illustrates leaching recovery efficiency for electrodes, according to some embodiments. As indicated, upon increasing the number of electrodes, a slight decrease in the Ag recovery efficiency was observed, despite the efficiency resulted above 85% in all cases. FIG. 32 illustrates an XRD pattern of Ag and Ag deposited on ZnO, according to some embodiments. After the leaching process, the filtered solution was treated by adjusting the pH up to 8.0 to remove Cu(II) as copper hydroxide, then it was filtered again and treated in the presence of ZnO photocatalyst under UV-Visible light radiation, thus obtaining an Ag/ZnO photocatalyst. The solid material was then treated, obtaining metallic silver.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

What is claimed is:

1. A method of recovering gold from a metal combination, the method comprising:
contacting a metal combination with a first leaching liquid sufficient to oxidize one or more additional metals of the metal combination to produce an oxidized product liquid and a recovered gold product, wherein the first leaching liquid includes chloride ions.

2. The method of claim 1, wherein the one or more additional metals include at least one of silver, copper, nickel, and palladium.

3. The method of claim 1, wherein the first leaching liquid includes at least one of sodium chloride, copper chloride, copper sulfate, and an iodide-containing compound.

4. The method of claim 1, wherein a pH value of the first leaching liquid ranges from about 4 pH to about 6 pH.

5. The method of claim 1 further comprising contacting the recovered gold product with a second leaching liquid including at least one of glycine and hydrogen peroxide to produce a gold solution, wherein a pH value of the second leaching liquid is greater than the first leaching liquid.

6. The method of claim 5 further comprising photocatalytically depositing gold in the gold solution on zinc oxide.

7. The method of claim 6 further comprising dissolution of zinc oxide at a pH value below about 6.3.

8. A system for recovering gold from a metal combination, the system comprising:
a first reactor including a first reservoir and a first leaching liquid capable of oxidizing one or more metals in a metal combination to produce an oxidized product liquid and a recovered gold product, wherein the first leaching liquid includes chloride ions, and wherein the metal combination includes gold and one or more of silver, copper, nickel, and palladium; and
a second reactor including a second reservoir and a second leaching liquid for converting the recovered gold product to gold ions, wherein the second leaching liquid includes one or more of glycine and hydrogen peroxide, and wherein a pH value of the second leaching liquid is greater than a pH value of the first leaching liquid.

9. The system of claim 8 further comprising a third reactor including a third reservoir and a zinc oxide photocatalyst for producing a photocatalytic product, wherein the photocatalytic product includes metallic gold and zinc oxide, and wherein the pH value of the first leaching liquid is greater than 4 pH.

10. The system of claim 9 further comprising a fourth reactor including a fourth reservoir and a solvent for separating the metallic gold from the zinc oxide by dissolving the zinc oxide at a pH value less than 6.3 pH.

11. A method of selectively separating metals from a metal combination, the method comprising:
contacting a metal combination with a leaching liquid to oxidize one or more metals of the metal combination, wherein the metal combination includes two or more of silver, gold, copper, nickel, and palladium; and
treating the one or more oxidized metals and the leaching liquid by increasing a pH value of the leaching liquid, sufficient to precipitate at least one of the one or more oxidized metals and to form a pH adjusted liquid.

12. The method of claim 11, wherein the leaching liquid includes chloride ions, and the pH value of the leaching liquid is greater than about 4 pH.

13. The method of claim 11, wherein the one or more oxidized metals include at least one of silver, copper, nickel, and palladium, and wherein the pH adjusted liquid has a pH value between about 5 pH and about 8 pH.

14. The method of claim 11, wherein the precipitate includes copper and nickel.

15. The method of claim 14, further comprising photocatalytic deposition of precipitated copper on a first catalyst, wherein the first catalyst includes titanium dioxide.

16. The method of claim 11, wherein the pH adjusted liquid includes one or more of silver and palladium.

17. The method of claim 11 further comprising contacting the pH adjusted liquid with a second catalyst and a reducing agent.

18. The method of claim 17, wherein the second catalyst includes zinc oxide, and wherein the reducing agent includes ethanol.

19. The method of claim 17 further comprising photocatalytic deposition of silver on a third catalyst.

20. The method of claim 19, further comprising dissolution of the third catalyst at a pH value below about 6.3, wherein the third catalyst includes zinc oxide.
